(19) United States
(12) Patent Application Publication
(10) Pub. No.: US 2025/0327912 A1
(43) Pub. Date: Oct. 23, 2025

(54) PIC-based multichannel transceiver

(71) Applicant: LYTE AI, INC., Mountain View, CA (US)

(72) Inventors: Arman Hajati, San Carlos, CA (US); Yuval Gerson, Mountain View, CA (US); Adam Scofield, Los Angeles, CA (US); Andrew Sutton, Amaroo (AU); Yangjin Ma, Bellevue, WA (US); Alexander Shpunt, Saratoga, CA (US)

(21) Appl. No.: 18/864,557

(22) PCT Filed: May 15, 2023
(86) PCT No.: PCT/US2023/066982

§ 371 Date: Nov. 11, 2024

Related U.S. Application Data
(60) Provisional application No. 63/342,176, filed on May 16, 2022.

(51) Int. Cl. G01S 7/4914; G01S 7/481; G01S 17/89

(52) U.S. Cl. CPC G01S 7/4914; G01S 7/4817; G01S 17/89

(57) ABSTRACT

An optoelectronic apparatus (100, 500) includes a dual folding mirror (114, 510) mounted on a carrier substrate (112, 524) with first and second reflecting surfaces (520, 522) disposed at opposite angles. A plurality of identical photonic integrated circuits (PICs 108, 110, 320, 502, 504, 506, 508) are disposed on the carrier substrate. Each PIC includes an array of optical transceiver cells (314, 400) on a planar substrate with respective edge couplers (406) along an edge of the planar substrate, and an optical distribution tree (320) coupled to convey coherent radiation to the optical transceiver cells. A first PIC is disposed on the carrier substrate such that the edge of the first PIC is in proximity to the first reflecting surface, and a second PIC is rotated by 180° relative to the first PIC such that the edge of the second PIC is in proximity to the second reflecting surface.

### CROSS-REFERENCE TO RELATED APPLICATION

This application claims the benefit of U.S. Provisional Patent Application 63/342,176, filed May 16, 2022, whose disclosure is incorporated herein by reference.

### FIELD OF THE INVENTION

The present invention relates generally to devices and methods for optical sensing and imaging, and particularly to integrated photonic devices and systems incorporating such devices.

### BACKGROUND

In many optical sensing applications, multiple points on a target are irradiated by an optical beam or beams, and the reflected radiation from each point is processed to analyze properties of the target. In some applications, such as optical coherence tomography (OCT) and CW LiDAR, a coherent beam is transmitted toward the target, and the reflected radiation is sensed and processed coherently with the transmitted radiation. To sense the properties of the target with high resolution, the area of interest should be probed densely, either by scanning the transmitted beam over the area or by transmitting and sensing an array of multiple beams simultaneously. Scanning solutions, however, typically suffer from low throughput. Arrays of transmitters and receivers can improve throughput, but their resolution is limited by the pitches of the arrays, which are, in turn, limited by the sizes of the transmitters and receivers themselves.

The terms “optical.” “light,” and “optical radiation,” as used in the present description and in the claims, refer to electromagnetic radiation in any of the visible, infrared, and ultraviolet spectral ranges.

### SUMMARY

Embodiments of the present invention that are described hereinbelow provide improved systems, devices, and methods for optical sensing.

There is therefore provided, in accordance with an embodiment of the invention, an optoelectronic apparatus, including a carrier substrate and a dual folding mirror mounted on the carrier substrate and including first and second reflecting surfaces disposed at opposite angles relative to a normal to the carrier substrate. A plurality of identical photonic integrated circuits (PICs) each include a planar substrate, an array of optical transceiver cells disposed on the planar substrate and including respective edge couplers disposed along an edge of the planar substrate, and an optical distribution tree coupled to convey coherent radiation from a radiation source to the optical transceiver cells. The plurality of the identical PICs includes a first PIC disposed on the carrier substrate such that the edge of the first PIC is in proximity to the first reflecting surface and a second PIC rotated by 180° relative to the first PIC and disposed on the carrier substrate such that the edge of the second PIC is in proximity to the second reflecting surface.

In a disclosed embodiment, the dual folding mirror has a triangular profile, wherein the first and second reflecting surfaces are oriented respectively at +45° and −45° relative to the normal.

Additionally or alternatively, the edge couplers in each PIC are disposed along the edge with a predefined pitch between the edge couplers, and the first and second PICs are disposed on the carrier substrate such that the edge couplers on the first PIC are displaced relative to the edge couplers on the second PIC by half the predefined pitch.

In some embodiments, each PIC includes a central region in which the edge couplers are disposed along the edge with a first pitch between the edge couplers, a first peripheral region at a first side of the central region in which no edge couplers are disposed along the edge, and a second peripheral region at a second side of the central region, opposite the first side, in which the edge couplers are disposed with a second pitch, which is finer than the first pitch. In a disclosed embodiment, the second pitch is half the first pitch.

Additionally or alternatively, the plurality of the identical PICs includes a third PIC disposed on the carrier substrate alongside the first PIC such that the edge of the third PIC is in proximity to the first reflecting surface, and a fourth PIC rotated by 180° relative to the first PIC and disposed on the carrier substrate alongside the second PIC such that the edge of the fourth PIC is in proximity to the second reflecting surface.

Typically, the optical distribution tree includes a network of waveguides and switches disposed on the planar substrate.

In some embodiments, the optical transceiver cells are configured to direct coherent radiation through the respective edge couplers via the dual folding mirror toward a target, to receive optical radiation from the target via the dual folding mirror through the respective edge couplers, to mix a part of the coherent radiation with the optical radiation received through the edge couplers, and to output electrical signals responsively to the mixed radiation. Typically, the edge couplers define respective optical apertures of the optical transceiver cells, and the apparatus includes one or more optical elements configured to image the optical apertures onto the target, thereby defining respective fields of view of the optical transceiver cells. In a disclosed embodiment, the apparatus includes a scanner, which is configured to scan the fields of view of the optical transceiver cells across the target.

There is also provided, in accordance with an embodiment of the invention, an optoelectronic device, including a planar substrate and an array of optical transceiver cells disposed on the substrate. Each transceiver cell includes an optical transducer configured to couple optical radiation between the transceiver cell and a target external to the substrate. An optical distribution tree includes a hierarchical network of switches interconnected by waveguides disposed on the substrate and coupled to convey coherent radiation from a radiation source to the optical transceiver cells. The hierarchical network includes at least a first tier of first switches having a first switching time and a second tier of second switches having a second switching time different from the first switching time. A controller is configured to actuate the switches so as to select different subsets of the optical transceiver cells to receive the coherent radiation from the radiation source at different times.

In some embodiments, each first switch in the first tier has at least two first outputs coupled respectively to at least two of the second switches in the second tier, while each second switch in the second tier has at least two second outputs coupled to the transceiver cells, and the first switching time is shorter than the second switching time. In a disclosed embodiment, the optical transceiver cells and the second switches are arranged in first and second groups in different, respective first and second areas of the substrate, and the waveguides interconnect the first and second switches such that one of the first outputs of each first switch is coupled to the first group of the transceiver cells and second switches, while another of the first outputs of each first switch is coupled to the second group of the transceiver cells and second switches.

In some embodiments, the device includes a scanner, which is configured to scan respective fields of view of the optical transceiver cells across the target, wherein the controller is configured to actuate the switches so as to select different subsets of the optical transceiver cells to convey the coherent radiation toward the target during different sweeps of the scanner across the target. In one embodiment, scanning the respective fields of view of the optical transceiver cells across the target defines multiple, respective scan lines across the target, wherein the first switching time is shorter than the second switching time, and wherein the controller is configured to actuate the first switches so as to activate a different group of the scan lines in each sweep across the target. Additionally or alternatively, the controller is configured to actuate the switches so as to activate the scan lines selectively in a region of interest on the target.

In a disclosed embodiment, the controller is configured to process signals output by the transceiver cells to produce a three-dimensional (3D) map of the target.

The switches may include thermo-optic switches.

There is additionally provided, in accordance with an embodiment of the invention, a thermo-optic switch, including an interferometer including first and second waveguides having respective input ends and output ends, and first and second heaters configured to heat the first and second waveguides, respectively. A splitter is coupled to receive a coherent optical signal and to input the optical signal to the input ends both the first and second waveguides. A mixer is coupled to receive and mix the optical signal from the output ends of the first and second waveguides and to direct the mixed optical signal to a first output or a second output of the switch depending on a phase shift between the first and second waveguides. A controller is coupled to control the first and second heaters so as to switch the mixed optical signal between the first and second outputs.

In some embodiments, the controller is configured to drive the first and second heaters in alternation to toggle the mixed optical signal between the first and second outputs. In a disclosed embodiment, the controller is configured to drive the first and second heaters with a voltage waveform that includes a pre-emphasis pulse each time the outputs are toggled. Additionally or alternatively, the controller is configured to drive the first and second heaters with respective voltages that cause respective temperatures of the first and second waveguides increase continually over multiple cycles of toggling between the first and second outputs.

In a disclosed embodiment, the controller includes first and second digital/analog converters (DACs), which are configured to apply respective voltages to the first and second heaters responsively to respective digital inputs.

There is further provided, in accordance with an embodiment of the invention, an optical beam displacer, which includes first and second microlens arrays, including microlenses disposed in respective first and second planes and having a common, predefined pitch. One or more layers of a birefringent material are contained between the first and second microlens arrays. Each layer has a thickness and birefringence selected such that light of a first polarization entering the layer through one of the microlenses is displaced laterally by a distance equal to the pitch of the microlens arrays, while light of a second polarization, orthogonal to the first polarization, passes through the layer without being displaced.

In some embodiments, the optical beam displacer includes, between the first and second microlens arrays, together with the birefringent material, a directional polarization rotator, configured to rotate by 90° a polarization of the light passing therethrough in a given direction without rotating the polarization of the light passing therethrough in an opposite direction. In a disclosed embodiment, the polarization rotator includes a Faraday rotator and a half-wave plate.

Additionally or alternatively, the one or more layers of the birefringent material include a first layer adjacent to the first microlens array and a second layer adjacent to the second microlens array, wherein the directional polarization rotator is contained between the first and second layers of the birefringent material. In one embodiment, the first and second layers of the birefringent material are oriented so that both the first and second layers displace the light of the first polarization laterally in the same direction. In an alternative embodiment, the first and second layers of the birefringent material are oriented so that the first and second layers displace the light of the first polarization laterally in opposite directions.

There is moreover provided, in accordance with an embodiment of the invention, optical apparatus, including an optical beam displacer as described above and a photonic integrated circuit (PIC), including at least one row of optical couplers, which are spaced apart by the predefined pitch and are aligned with the first microlens array so as to couple respective beams of light between the optical couplers and respective microlenses in the first array. Thus, the beams of the first and second polarizations that are coupled into and out of adjacent optical couplers in the at least one row are combined at the second microlens array.

In some embodiments, the optical couplers include edge couplers. In one embodiment, a turning mirror is disposed between the edge couplers and the device.

Alternatively, the optical couplers include vertical couplers disposed on a surface of the PIC. In a disclosed embodiment, the vertical couplers are disposed in a two-dimensional matrix of locations on the surface of the PIC, and the first and second microlens arrays include two-dimensional arrays of the microlenses, which are aligned with the two-dimensional matrix of the vertical couplers.

There is furthermore provided, in accordance with an embodiment of the invention, optical apparatus, which includes a photonic integrated circuit (PIC), including at least one row of vertical couplers, which are disposed on a surface of the PIC and are spaced apart by a predefined pitch and are configured to couple respective beams of light into and out of the PIC while collimating the respective beams. An optical beam displacer is disposed over the PIC and includes a microlens array, including microlenses disposed in a plane, spaced apart by the predefined pitch, and aligned with the vertical couplers, and one or more layers of a birefringent material contained between the PIC and the microlens array. Each layer has a thickness and birefringence selected such that light of a first polarization entering the layer through one of the microlenses or the vertical couplers is displaced laterally by a distance equal to the pitch, while light of a second polarization, orthogonal to the first polarization, passes through the layer without being displaced.

In some embodiments, the optical beam displacer includes, between the microlens array and the PIC, together with the birefringent material, a directional polarization rotator, configured to rotate by 90° a polarization of the light passing therethrough in a given direction without rotating the polarization of the light passing therethrough in an opposite direction. In a disclosed embodiment, the one or more layers of the birefringent material include a first layer adjacent to the first microlens array and a second layer adjacent to the PIC, wherein the directional polarization rotator is contained between the first and second layers of the birefringent material.

There is also provided, in accordance with an embodiment of the invention, optical apparatus, which includes a photonic integrated circuit (PIC), including at least one row of optical couplers, which are spaced apart by a predefined pitch and are configured to couple respective beams of light into and out of the PIC. A prism including a birefringent material is disposed in proximity to the row of optical couplers. The prism has a birefringence and prism angle selected such that light of a first polarization passing through the prism to or from one of the optical couplers is deflected by a first angle, while light of a second polarization, orthogonal to the first polarization, is deflected by a second angle, different from the first angle, while passing through the prism. The first and second angles are chosen so that the beams of the first and second polarizations that are coupled into and out of adjacent optical couplers in the at least one row are combined by the prism.

There is additionally provided, in accordance with an embodiment of the invention, an optical device, including a substrate and a polarization splitter disposed on the substrate. The polarization splitter includes a first waveguide having a first end configured to receive an input beam including both TE and TM polarization components, a second end configured to output the TE polarization component, and a first tapered segment having a first width that decreases in a direction from the first end toward the second end. A second waveguide has a second tapered segment in proximity to the first tapered segment, with a second width that increases in the direction from the first end toward the second end, such that the TM polarization component is coupled from the first tapered segment into the second tapered segment.

In a disclosed embodiment, the device includes a polarization rotator disposed on the substrate and coupled to receive the TM polarization component from the second waveguide and to convert the TM polarization component to a TE polarization.

There is further provided, in accordance with an embodiment of the invention, signal processing apparatus, including an array of coherent detection cells. Each cell includes a detector configured to output a respective beat signal in response to radiation received by the cell and a mixer, which is coupled to mix the respective beat signal with a carrier wave at a respective modulation frequency, whereby the coherent detection cells output respective modulated signals at different, respective modulation frequencies. An analog summer is coupled to sum the modulated signals output by the array of coherent detection cells so as to output a summed signal. An analog-to-digital converter (ADC) is coupled to digitize the summed signal so as to output a digital data stream. Processing circuitry is configured to demultiplex the digital data stream into multiple frequency channels at the respective modulation frequencies and to extract the respective beat frequency from each of the frequency channels.

In a disclosed embodiment, the processing circuitry is configured to demultiplex the digital data stream into the multiple frequency channels by transforming the digital data stream to a frequency domain and identifying a respective pair of peaks in the transformed data stream that are separated by twice the respective modulation frequency of each cell.

In some embodiments, each of the coherent detection cells includes respective first and second mixers, which are configured to mix the respective beat signal with respective first and second carrier waves at different, respective first and second modulation frequencies, such that the coherent detection cells output respective first and second modulated signals with different, respective frequency differences between the first and second modulated signals output by each of the coherent detection cells. The processing circuitry demultiplexes the digital data stream into the multiple frequency channels responsively to the respective frequency differences. In a disclosed embodiment, the analog summer includes first and second summers, which are coupled respectively to sum the first modulated signals and to sum the second modulated signals that are output respectively by the first and second mixers in the coherent detection cells, and the ADC includes first and second ADCs, which are coupled to receive and digitize respective first and second summed signals output respectively by the first and second summers so as to generate first and second data streams for input to the processing circuitry.

There is moreover provided, in accordance with an embodiment of the invention, an optical apparatus, including a first substrate and a first array of photonic integrated circuits (PICs) disposed on the first substrate. Each PIC includes one or more optical edge couplers adjacent to an upper surface of the first substrate. A second substrate includes a second array of turning mirrors and is mounted on the upper surface of the first substrate such that each turning mirror in the second array is aligned with the one or more optical edge couplers on a respective one of the PICs, whereby light is coupled into and out of the optical edge couplers via the turning mirrors.

In a disclosed embodiment, the turning mirrors have respective reflective surfaces inclined at 45° relative to a lower surface of the second substrate, which is mounted on the upper surface of the first substrate.

In some embodiments, the first and second substrates include semiconductor materials, which are patterned and etched to create the PICS and the turning mirrors. Additionally or alternatively, the first substrate is patterned to define cavities between the PICs, with the edge couplers adjacent to respective ones of the cavities, and the second substrate is patterned so that the turning mirrors protrude into the cavities in proximity to the edge couplers when the second substrate is mounted on the upper surface of the first substrate.

There is furthermore provided, in accordance with an embodiment of the invention, a method for producing an optoelectronic device. The method includes mounting on a carrier substrate a dual folding mirror including first and second reflecting surfaces disposed at opposite angles relative to a normal to the carrier substrate. A plurality of identical photonic integrated circuits (PICs) are mounted on the carrier substrate. Each PIC includes a planar substrate, an array of optical transceiver cells disposed on the planar substrate and including respective edge couplers disposed along an edge of the planar substrate, and an optical distribution tree coupled to convey coherent radiation from a radiation source to the optical transceiver cells. The plurality of the identical PICs includes a first PIC mounted on the carrier substrate such that the edge of the first PIC is in proximity to the first reflecting surface and a second PIC rotated by 180° relative to the first PIC and mounted on the carrier substrate such that the edge of the second PIC is in proximity to the second reflecting surface.

There is also provided, in accordance with an embodiment of the invention, a method for producing an optoelectronic device. The method includes forming on a planar substrate an array of optical transceiver cells, each transceiver cell including an optical transducer configured to couple optical radiation between the transceiver cell and a target external to the substrate. An optical distribution tree, including a hierarchical network of switches interconnected by waveguides disposed on the substrate, is coupled to convey coherent radiation from a radiation source to the optical transceiver cells. The hierarchical network includes at least a first tier of first switches having a first switching time and a second tier of second switches having a second switching time different from the first switching time. A controller is coupled to actuate the switches so as to select different subsets of the optical transceiver cells to receive the coherent radiation from the radiation source at different times.

There is additionally provided, in accordance with an embodiment of the invention, a method for switching, which include providing a thermo-optic switch, including an interferometer including first and second waveguides having respective input ends and output ends, first and second heaters configured to heat the first and second waveguides, respectively, a splitter coupled to receive a coherent optical signal and to input the optical signal to the input ends both the first and second waveguides, and a mixer coupled to receive and mix the optical signal from the output ends of the first and second waveguides and to direct the mixed optical signal to a first output or a second output of the switch depending on a phase shift between the first and second waveguides. The first and second heaters are controlled so as to switch the mixed optical signal between the first and second outputs.

There is further provided, in accordance with an embodiment of the invention, a method for optical beam displacement. The method includes providing first and second microlens arrays, including microlenses disposed in respective first and second planes and having a common, predefined pitch. One or more layers of a birefringent material are inserted between the first and second microlens arrays. Each layer has a thickness and birefringence selected such that light of a first polarization entering the layer through one of the microlenses is displaced laterally by a distance equal to the pitch of the microlens arrays, while light of a second polarization, orthogonal to the first polarization, passes through the layer without being displaced.

There is moreover provided, in accordance with an embodiment of the invention, a method for optical beam displacement, which includes providing a photonic integrated circuit (PIC), including at least one row of vertical couplers, which are disposed on a surface of the PIC and are spaced apart by a predefined pitch and are configured to couple respective beams of light into and out of the PIC while collimating the respective beams. An optical beam displacer is provided, including a microlens array, which includes microlenses disposed in a plane and spaced apart by the predefined pitch, and one or more layers of a birefringent material contained between the PIC and the microlens array. Each layer has a thickness and birefringence selected such that light of a first polarization entering the layer through one of the microlenses or the vertical couplers is displaced laterally by a distance equal to the pitch, while light of a second polarization, orthogonal to the first polarization, passes through the layer without being displaced. The optical beam displacer is positioned over the PIC so that the microlenses are respectively aligned with the vertical couplers.

There is furthermore provided, in accordance with an embodiment of the invention, a method for optical beam displacement, which includes providing a photonic integrated circuit (PIC), including at least one row of optical couplers, which are spaced apart by a predefined pitch and are configured to couple respective beams of light into and out of the PIC. A prism including a birefringent material is positioned in proximity to the row of optical couplers. The prism has a birefringence and prism angle selected such that light of a first polarization passing through the prism to or from one of the optical couplers is deflected by a first angle, while light of a second polarization, orthogonal to the first polarization, is deflected by a second angle, different from the first angle, while passing through the prism, and the first and second angles are chosen so that the beams of the first and second polarizations that are coupled into and out of adjacent optical couplers in the at least one row are combined by the prism.

There is also provided, in accordance with an embodiment of the invention, a method for optical beam control, which includes forming on a substrate a first waveguide having a first end configured to receive an input beam including both TE and TM polarization components, a second end configured to output the TE polarization component, and a first tapered segment having a first width that decreases in a direction from the first end toward the second end. A second waveguide is formed on the substrate, the second waveguide having a second tapered segment in proximity to the first tapered segment, with a second width that increases in the direction from the first end toward the second end, such that the TM polarization component is coupled from the first tapered segment into the second tapered segment.

There is additionally provided, in accordance with an embodiment of the invention, a method for signal processing, which includes providing an array of coherent detection cells, each cell including a detector configured to output a respective beat signal in response to radiation received by the cell. The respective beat signal output by each cell is mixed with a carrier wave at a respective modulation frequency, whereby the coherent detection cells output respective modulated signals at different, respective modulation frequencies. The modulated signals output by the array of coherent detection cells are summed so as to produce a summed analog signal. The summed analog signal is digitized so as to produce a digital data stream. The digital data stream is demultiplexed into multiple frequency channels at the respective modulation frequencies. The respective beat frequency is extracted from each of the frequency channels.

There is further provided, in accordance with an embodiment of the invention, a method for optical fabrication, which includes forming a first array of photonic integrated circuits (PICs) on a first substrate. Each PIC includes one or more optical edge couplers adjacent to an upper surface of the first substrate. A second array of turning mirrors is formed on a second substrate. The second substrate is mounted on the upper surface of the first substrate such that each turning mirror in the second array is aligned with the one or more optical edge couplers on a respective one of the PICs, whereby light is coupled into and out of the optical edge couplers via the turning mirrors.

The present invention will be more fully understood from the following detailed description of the embodiments thereof, taken together with the drawings in which:

### BRIEF DESCRIPTION OF THE DRAWINGS

FIG. 1 is a schematic pictorial illustration of a scanning transceiver array device, in accordance with an embodiment of the invention;

FIG. 2 is a block diagram that schematically shows details of the transceiver array of FIG. 1, in accordance with an embodiment of the invention;

FIG. 3 is a schematic top view of a photonic integrated circuit (PIC) comprising a hierarchical optical switching network, in accordance with an embodiment of the invention;

FIG. 4 is a schematic detail view of a transceiver cell (TC) that can be used in the PIC of FIG. 3, in accordance with an embodiment of the invention;

FIG. 5 is a schematic frontal view of a transceiver device comprising four PICs and a central turning mirror, in accordance with an embodiment of the invention;

FIGS. 6A, 6B, 6C and 6D are schematic frontal views of successive scan patterns applied across a scene by a switched optical sensing system, in accordance with an embodiment of the invention;

FIG. 7A is a block diagram that schematically illustrates an optical switching tree on a PIC, in accordance with an embodiment of the invention;

FIG. 7B shows two plots that schematically illustrate the response of a thermo-optic switch to voltages applied to resistive heaters of the switch, in accordance with an embodiment of the invention;

FIGS. 8A, 8B, and 8C show plots that schematically illustrate a voltage control scheme for a thermo-optic switch and a response of the switch to the applied voltages, in accordance with alternative embodiments of the invention;

FIG. 9A is a block diagram that schematically illustrates an optical switching tree on a PIC including a fast thermo-optic switch, in accordance with another embodiment of the invention;

FIG. 9B shows three plots that schematically illustrate a voltage control scheme for a thermo-optic switch and a response of the switch to the applied voltages, in accordance with another embodiment of the invention;

FIGS. 10-13 are schematic top views of micro-optic beam displacers, in accordance with various embodiments of the invention;

FIGS. 14 and 15 are schematic side and top views, respectively, of a transceiver array device with micro-optic beam displacers, in accordance with an embodiment of the invention;

FIGS. 16 and 17 are schematic side and top views, respectively, of a transceiver array device with micro-optic beam displacers, in accordance with another embodiment of the invention;

FIGS. 18 and 19 are schematic side and top views, respectively, of a transceiver array device with micro-optic beam displacers, in accordance with yet another embodiment of the invention;

FIGS. 20-22 are schematic side views of transceiver array devices with micro-optic beam displacers, in accordance with other embodiments of the invention;

FIGS. 23A and 23B are schematic side views of a birefringent prism, in accordance with an embodiment of the invention;

FIG. 23C is a schematic side view of a beam displacer based on a birefringent prism, in accordance with an embodiment of the invention;

FIG. 24A is a block diagram that schematically illustrates a polarization beamsplitter rotator (PBSR), which is implemented on a PIC in accordance with an embodiment of the invention;

FIG. 24B is a schematic top view of a polarization beamsplitter, in accordance with an embodiment of the invention;

FIG. 24C is a schematic top view of the PBSR of FIG. 24A, in accordance with another embodiment of the invention;

FIG. 25A is a block diagram that schematically illustrates a signal processing scheme for use with a transceiver array, in accordance with an embodiment of the invention;

FIG. 25B is a schematic plot of signal outputs from some of the channels of the transceiver array of FIG. 25A, in accordance with an embodiment of the invention;

FIGS. 26 and 27 are block diagrams that schematically illustrates signal processing schemes for use with a transceiver array, in accordance with alternative embodiments of the invention; and

FIG. 28A is a schematic pictorial illustration showing an array of edge-emitting PICs and turning mirrors, in accordance with an embodiment of the invention; and

FIG. 28B is a schematic sectional view showing a detail of the array of FIG. 28A.

### DETAILED DESCRIPTION OF EMBODIMENTS

### Overview

PCT International Publication WO 2023/023106, whose disclosure is incorporated herein by reference, describes transceiver arrays and scanning systems that are able to scan a target with high resolution and high throughput. The embodiments described in this publication use photonic transceiver chips. Each chip includes optical components for transmitting and sensing a beam of radiation, along with ancillary electronics. To reduce the size and power requirements of the transceiver chips, the beams that are to be transmitted may be generated centrally, by a core transceiver engine, and then multiplexed among the individual transceivers, also referred to herein as transceiver cells. A scanner, such as an optomechanical scanning device, scans the beams of all the transceivers over the area of interest so that the area is covered densely—with resolution finer than the pitch of the array—and with high throughput. The multiplexing and scanning may be controlled to tailor the scan area and resolution to application requirements.

The above-mentioned PCT publication describes a variety of array geometries and scan patterns that can be used for these purposes. Other transceiver arrays and scanning systems are described in PCT International Publications WO 2023/023105 and WO 2023/034465 and in PCT Patent Application PCT/US2022/47516, filed Oct. 24, 2022. All the above PCT publications and applications are assigned to the assignee of the present patent application, and their disclosures are incorporated herein by reference.

The photonic transceiver chips themselves are typically produced using photonic integrated circuit (PIC) technology. These chips are designed to meet application requirements, such as the sensing mode (for example, coherent or non-coherent, as well as sensitivity), the mode of input/output coupling (for example, vertically or through the edge of the chip, via a grating or via a mirror), and wavelength characteristics (spectral range, and single- or multiple-wavelength sensing).

PIC technology is not yet capable of achieving the high density and high yield of electronic integrated circuits (EICs), such as CMOS chips. Therefore, for practical reasons, it can be advantageous to use several PICs, arranged together on a common carrier substrate, in creating a full transceiver array. Furthermore, it can also be useful to separate the functions of electronic control, logic, and signal processing onto an EIC, which is closely coupled to the PIC on which the transceiver array itself is formed. The above-mentioned PCT publications and patent applications describe embodiments using closely-coupled PICs and EICs. In one of these embodiments, described in PCT/US2022/47516, an EIC is mounted on a PIC and performs control and/or signal processing functions in connection with the optoelectronic components of the PIC.

The embodiments that are described hereinbelow expand on the concepts and implementations set forth in the above-mentioned publications and patent applications. The present embodiments are directed to improving the optical quality and density of scan coverage, as well as enabling efficient production and assembly of compact, low-cost transceiver array devices. Although the disclosed embodiments are directed to optical sensing, in the visible, infrared, or ultraviolet range, the principles of the present invention may alternatively be applied, mutatis mutandis, in other spectral ranges, such as microwave and millimeter wave radiation.

### System Architecture

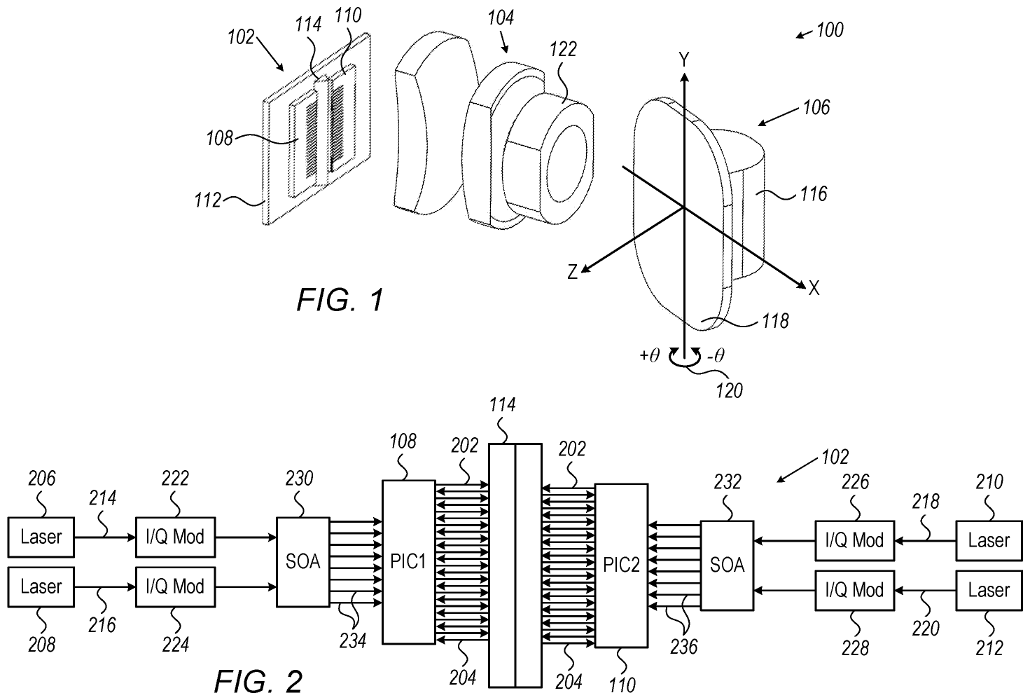

FIG. 1 schematically illustrates a scanning transceiver array device 100, in accordance with an embodiment of the invention. Device 100 comprises a transceiver array 102, optics 104, and a scanner 106. Transceiver array 102 comprises a pair of edge-emitting PICs 108 and 110, which are mounted on a common carrier substrate 112. PICs 108 and 110 emit respective sets of beams toward a central triangular (knife-edge) mirror 114, which turns the beams away from substrate 112. Some transceiver arrays and mirrors of this sort are shown in the figures that follow, and others are described in the above-mentioned PCT publications and patent applications.

Scanner 106 comprises a galvanometer 116 and a galvanometer mirror 118. Optics 104 collimate and direct the beams emitted by PICs 108 and 110 and reflected by mirror 114 toward galvanometer mirror 118. The mirror turns about the vertical (Y) axis in positive and negative angles +θ and −θ, as shown by a double-arrow 120, thus scanning each of the beams output from PICs 108 and 110 along the horizontal (XZ) plane. In addition, optics 104 can be displaced along the vertical axis, thereby shifting each of the beams by small increments in the vertical direction. Transceiver array 102 may be “sparse,” meaning that the pitch of the array is large compared to the desired sensing resolution. Optics 104 comprise a projection lens 122, which maps this sparse array into angle space in the vertical direction; and the fine vertical movement of the optics can be used to fill the gaps in angle space and thus enhance the sensing resolution.

FIG. 2 is a block diagram that schematically shows details of transceiver array 102 of FIG. 1, in accordance with an embodiment of the invention. Each of the two PICs 108 and 110 generates an array of optical beams 202, which are emitted through the edge of the PIC toward central turning mirror 114. Each PIC 108 and 110 also receives returning radiation that is reflected from turning mirror 114 back to the edge of the PIC, with the returning radiation shown as beams 204.

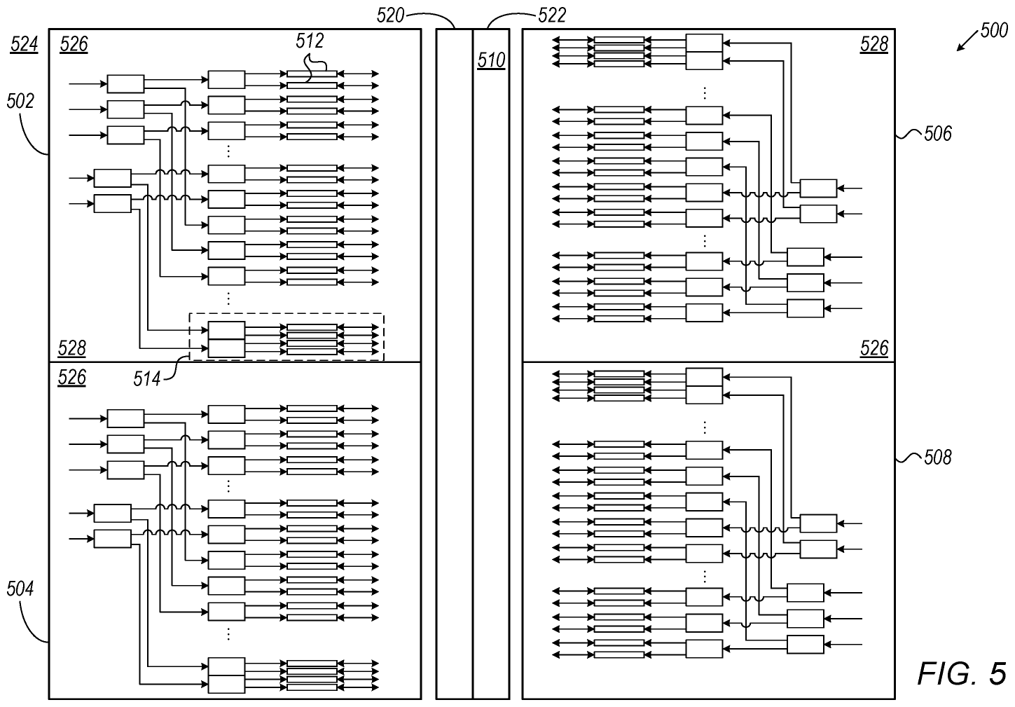

In the pictured example, each PIC 108 and 110 is fed by a pair of lasers, with lasers 206 and 208 feeding PIC 108 and lasers 210 and 212 feeding PIC 110. Beams 214 and 216 emitted by lasers 206 and 208 and beams 218 and 220 emitted by lasers 210 and 212 are modulated (for example by respective I/Q modulators 222, 224, 226, and 228, or by direct current modulation). The beams are amplified by respective arrays of semiconductor optical amplifiers (SOA) 230 and 232, which may also include splitters to generate multiple output beams 234, 236. Amplified and split sets of beams 234 and 236 are distributed by a hierarchical network of switches within the respective PICs 108 and 110 into many separate output beams 202. As illustrated below in FIG. 5, the two PICs 108 and 110 can beneficially be vertically shifted relative to one another by half the pitch of the beams, thus effectively doubling the vertical resolution of the system.

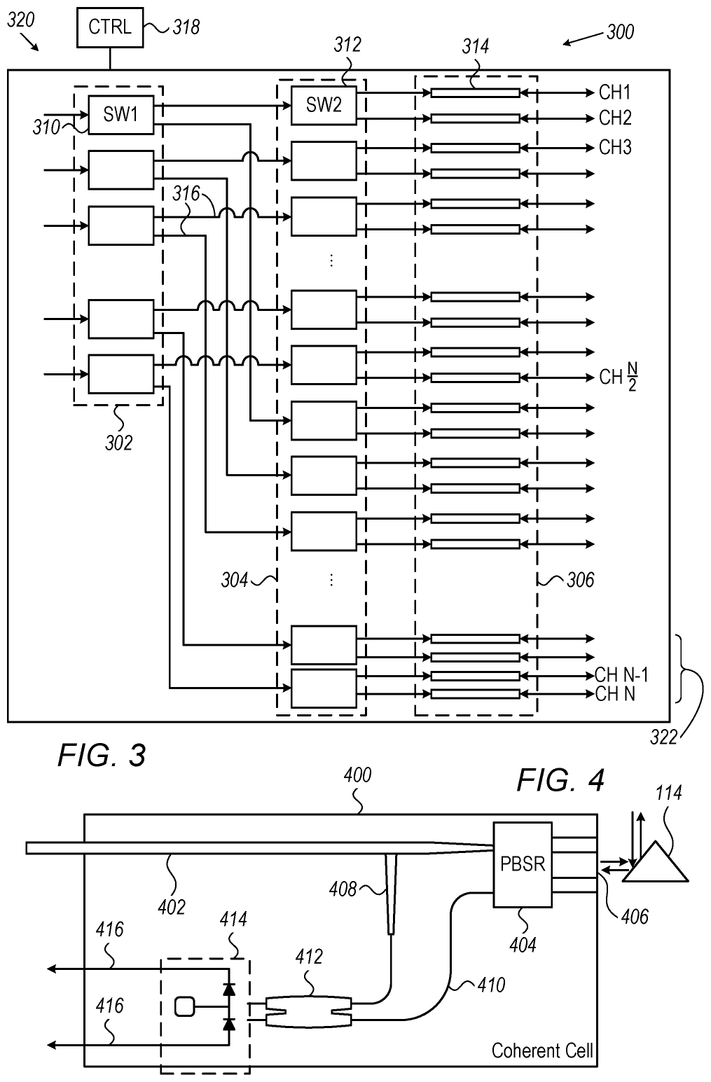

FIG. 3 is a block diagram that schematically shows details of a hierarchical optical switching network 320, serving as an optical distribution tree in a PIC 300, in accordance with an embodiment of the invention. The pictured network includes two tiers 302 and 304 of 1:2 switches 310 and 312 (each with one input and two outputs), labeled SW1 and SW2, interconnected by waveguides 316, all formed on a planar substrate, such as a silicon-on-insulator (SOI) substrate. Alternatively, switches 310 and/or 312 may switch between larger numbers of outputs.

Switches 310 and 312 distribute output beams via waveguides 316 on PIC 300 for transmission by an array 306 of transceiver cells (TC) 314. Alternatively, network hierarchies with larger numbers of tiers may be used to generate larger numbers of output beams. Switches 310 and 312 are typically controlled by a controller 318, comprising suitable electronic logic and interface circuits, which may be implemented closely-coupled EIC (not shown in the figures). Controller 318 thus selects different subsets of the optical transceiver cells to receive the coherent radiation from the radiation source at different times. Each beam is input to a respective transceiver cell 314, including transmission and detection circuits, which transmits the outgoing (Tx) beam toward the target and receives and detects the return (Rx) beam.

In the embodiment of FIG. 3, optical transceiver cells 314 and switches 312 are arranged in two groups in different, respective areas of PIC 300. Waveguides 316 interconnect the switches 310 and 312 such that one of the outputs of each switch 310 is coupled to the first group of transceiver cells 314 and switches 312, while another of the outputs of each switch 310 is coupled to the other group of the transceiver cells and second-tier switches. Thus, each of switches (SW1) 310 in first tier 302 switches between a first waveguide 316 feeding the upper portion of transceiver array 306 (channels CH₁ to CH_{N/2}) and a second waveguide 316 feeding the lower portion of transceiver array 306 (channels CH_{N/2+1} to CH_{N}). The waveguides from SW1 switches 310 to the corresponding SW2 switches 312 may cross one another, as shown in the figure, either in the same layer or in different layers of PIC 300. This arrangement of the SW1 switches and waveguides is advantageous in enabling the active area of the transceiver array to be switched between upper and lower windows, served respectively by the first and second branches of the switch connections. (The terms “upper.” “lower,” “vertical,” and “horizontal” are used for the sake of convenience in the present description in relation to the orientation of the drawings and do not necessarily bear any relation to the orientation of the transceiver device itself.) This sort of switching between windows is useful in enabling controller 318 to select a certain region or window of interest for measurement and processing.

In some embodiments, the switches in the different tiers 302, 304 may have different characteristics, for example different switching speeds (or equivalently, different switching times). Slower switches are typically less costly to implement in terms of chip real estate and power consumption, but fast switches are desirable to enable rapid switching between different regions of interest or different scan lines. Various types of switches may be used for these purposes. Some embodiments that are described hereinbelow use thermo-optic switches, with drive circuits and waveforms that support fast switching rates, as described further hereinbelow.

In one embodiment, SW1 switches 310 in first tier 302 have fast switching times, while SW2 switches 312 in second tier 304 have slower switching times. While the SW1 switches are set to transfer the output beams to the upper window, for example, the slower SW2 switches can be set to select a certain subset of the transceiver cells in the lower window. Once the SW2 switches have settled, the SW1 switches can be switched rapidly to transfer the beams to the selected transceiver cells in the lower window.

In alternative embodiments, the SW1 switches are slow, while the SW2 switches or another, intermediate tier of switches are fast.

At the bottom of array 306, a group 322 of transceiver cells 314 and the corresponding waveguides 316 is intentionally packed more densely than in the remainder of the array. For example, the pitch of group 322 may be half the pitch of the central part of array 306. This arrangement facilitates stitching together the sensing areas of the two PICs 300 on the opposite sides of turning mirror 114, as explained further hereinbelow. Alternatively or additionally, local variations in the density of the transceiver cells can be used for other purposes, such as different stitching schemes and creating variations in local sensing density.

FIG. 4 is a schematic detail view of a transceiver cell (TC) 400 that can be used in array 306 of FIG. 3, in accordance with an embodiment of the invention. In the present example, the transceiver cells are assumed to be coherent sensing cells, which direct coherent radiation through respective edge couplers 406 via dual folding mirror 114 toward a target, receive optical radiation from the target via the dual folding mirror through the respective edge couplers, mix a part of the coherent radiation with the optical radiation received through the edge couplers, and output electrical signals responsively to the mixed radiation. Edge couplers 406 define respective optical apertures of the optical transceiver cells. Optical elements, such as lens 122 (FIG. 1) image the optical apertures onto the target, thereby defining the field of view of the optical transceiver cell. Scanner 106 scans the fields of view of the optical transceiver cell across the target.

For purposes of coherent sensing, TC 400 comprises 2×2 couplers 412 and balanced photodiode pairs (BPDs) 414. The outgoing beam for transmission passes through a waveguide 402 at the upper side of cell 400 and exits through a polarization beamsplitter rotator (PBSR) 404 and edge coupler 406 to turning mirror 114. A part of the outgoing beam is split off within the transceiver cell into a waveguide 408 to serve as a local oscillator (LO) beam. The incoming beam reflected from the target is directed by PBSR 404 into a receive waveguide 410 and is mixed with the LO beam in 2×2 coupler 412. BPD pair 414 senses the output of the 2×2 coupler and outputs an electrical signal 416 for processing by the EIC.

Various other sorts of sensing and transceiver cells that can be used in embodiments of the are described in the above-mentioned PCT publications and patent application. Alternatively, other types of transceiver cells may be used.

FIG. 5 is a schematic frontal view of a transceiver device 500 comprising four PICs 502, 504, 506, and 508 and a central turning mirror 510, all mounted on a carrier substrate 524, in accordance with an embodiment of the invention. Turning mirror 510 comprises reflecting surfaces 520 and 522, which are disposed at opposite angles relative to a normal to the carrier substrate, for example at +45° and −45° relative to the normal. PICs 502, 504, 506, and 508 are substantially identical to PIC 300 (FIG. 3), and details of the PICs are omitted from FIG. 5 for the sake of simplicity. The four PICs 502, 504, 506, and 508 are positioned in pairs on opposite sides of turning mirror 510, in proximity to reflecting surfaces 520 and 522, with PICs 506 and 508 rotated by 180° relative to PICS 502 and 504.

The PICs on the opposite sides of turning mirror 510 are displaced laterally relative to one another on carrier substrate 524, so that the edge couplers of transceiver cells 512 of PICs 506 and 508 are displaced relative to PICs 502 and 504 by an offset equal to half the pitch of the transceiver cells 512. Thus, the output beams reflected from turning mirror 510 are interleaved along the vertical direction in a densely-spaced array.

Because of practical limitations in the fabrication of PICs 502, 504, 506, and 508, however, such as the need to leave space in the margins of the PIC dies for electrical connection pads, there are gaps in a peripheral region 526 of the transceiver arrays. To avoid corresponding gaps in the array of output beams, a group 514 of the transceiver cells in a peripheral region 528 at the other end of the array in each PIC is more densely packed together, as noted above in regard to FIG. 3. The PICS on the opposite sides of the turning mirrors are offset relative to one another so that dense group 514 of transceiver cells in one PIC is located opposite peripheral region 528 in the margin of the PIC on the other side of the turning mirror. For example, group 514 in PIC 502 is located opposite the lower margin of PIC 506. Thus, the transceiver device generates a uniform, densely-spaced array of output beams along the entire length of turning mirror 510.

Although transceiver device 500 comprises two PICs with corresponding transceiver arrays on each side of turning mirror 510, the principles of the present embodiment may alternatively be applied in devices comprising only a single PIC on each side of the turning mirror, or comprising three or more PICs on each side.

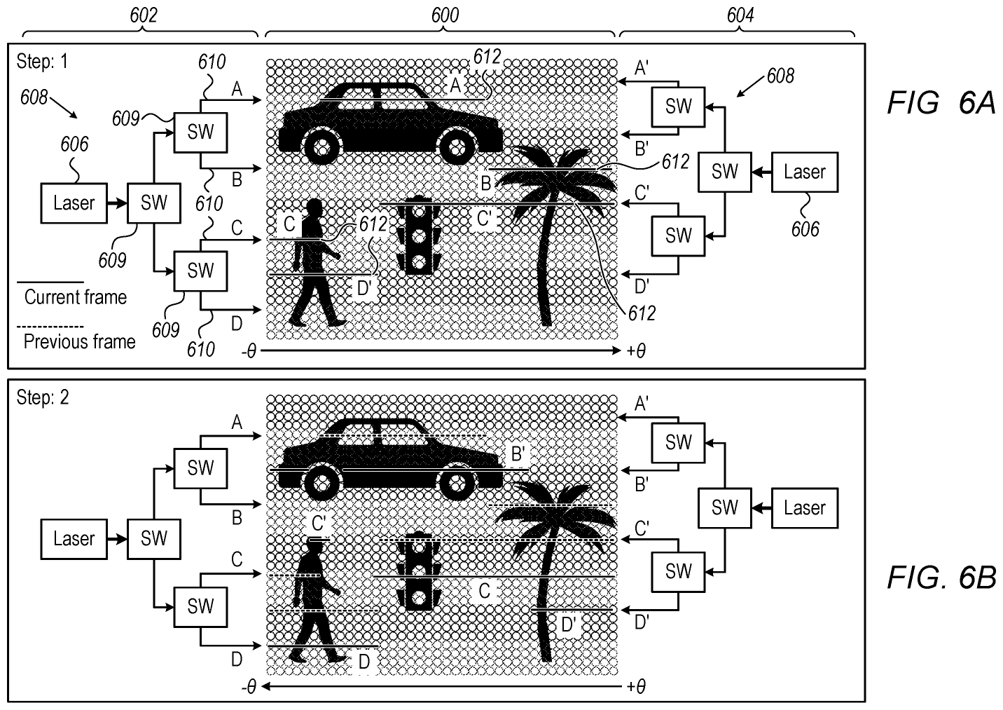

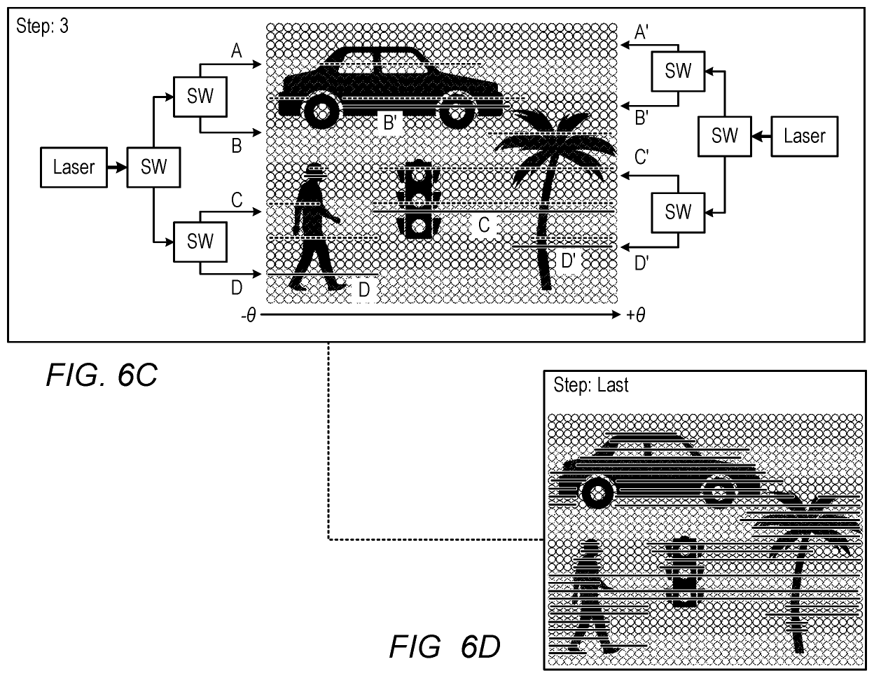

FIGS. 6A, 6B, 6C and 6D are schematic frontal views of successive scan patterns applied across a scene 600 by a switched optical sensing system, in accordance with an embodiment of the invention. In the present example, the sensing system includes two sensing devices 602 and 604 with staggered scan lines, which may be similar to sensing devices 108 and 110 as shown in FIG. 1. For simplicity of illustration, each sensing device 602, 604 includes a respective laser source 606 and an optical switching network 608, which distributes the laser radiation to transceiver cells 610. When particular transceiver cells are actuated by switching network 608, they give rise to respective scan lines 612, which are labeled A-D and A′-D′, respectively.

FIGS. 6A-D illustrate the use of preferential switching and application of optical power in the areas of interest in scene 600, i.e., areas that are considered to contain information of value, while reducing resource use in less interesting areas. In this embodiment, a scanner, such as scanner 106 in FIG. 1, scans the respective fields of view of the optical transceiver cells in an array across a target. A controller (such as controller 318 in FIG. 3) actuates the switches in the optical distribution tree so as to select different subsets of the cells to convey coherent radiation toward the target during different sweeps of the scanner across the target. The fields of view of the optical transceiver cells scan across the target in multiple, respective scan lines across the target, and the controller actuates the switches so as to activate the scan lines selectively in a region of interest on the target. The different switching times of the switches in the different tiers of the network, as described above, can be used to activate a different group of the scan lines in each sweep across the target.

In this example, optical switching networks 608 in devices 602 and 604 comprise switches 609, which switch quickly between transceiver cells 610 and thus actuate different scan lines, for example switching between lines A and B, between lines C and D, between lines A′ and B′, and between lines C′ and D′. A galvanometer mirror, such as mirror 118 (FIG. 1) scans alternately from left to right (as in “Step: 1,” FIG. 6A) and then from right to left (in “Step: 2,” FIG. 6B). After each pair of galvanometer scans, the scan lines are shifted vertically, for example by piezoelectric actuation of the optics or sensing devices (as described above), thus shifting the scan lines vertically by a small increment, for example by a single pixel in the output depth map.

Thus, in the frames marked Step: 1, Step: 2, and Step: 3 (FIGS. 6A, 6B and 6C), different switches 609 in optical switching networks 608 are actuated for different parts of each of the scans. Switches 609 are toggled in the middle of each scan line 612 in order to turn the corresponding transceiver cells on as the scan crosses a region of interest and off elsewhere. At the conclusion of the process (in “Step: Last.” FIG. 6D), each of the regions of interest has been covered by scan lines.

To summarize, the combination of mechanical and optical control in devices in accordance with embodiments of the invention provides several capabilities that enable focusing on regions of interest with high resolution and sensitivity:
The galvanometer mirror can be controlled to select the angular scan range and scanning speed along the horizontal direction. The scanning speed can be reduced in regions of interest to increase sensitivity and resolution in these areas. The optics can also be shifted vertically to select regions of interest and control the vertical scan density.
The switching networks in the transceiver PICs enable the outgoing beams to be multiplexed selectively over the scan lines that cross the regions of interest. Fast switching on the PIC can be used to change the scan lines within each sweep of the galvanometer mirror.
The integration time and gain of the processing electronics that receive the signals from each transceiver cell can be increased to enhance sensitivity in areas of the scene where signals are weak, as well as decreased to support higher scanning speeds and avoid saturation in other areas.

Using these capabilities, for example, the galvanometer mirror may scan at a higher speed in the margins of the scene than in the center. For parts of the scene at short range, the transceiver cells can be operated at lower integration time and gain. The integration time and gain can be increased in long-range parts of the scene. These increases may be implemented over entire scan lines or only over a certain part or parts of a scan line as the line traverses a region of interest, such as a window containing an object of interest that is relatively distant from the device. Further details and examples of these capabilities are presented in the above-mentioned PCT publications.

### Fast Thermo-Optic Switching

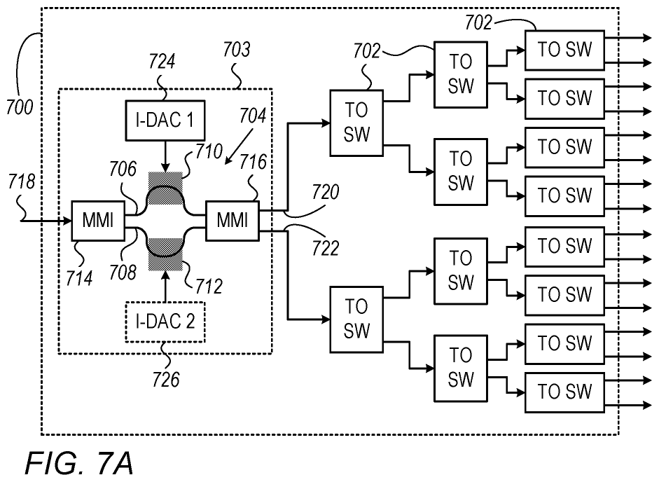

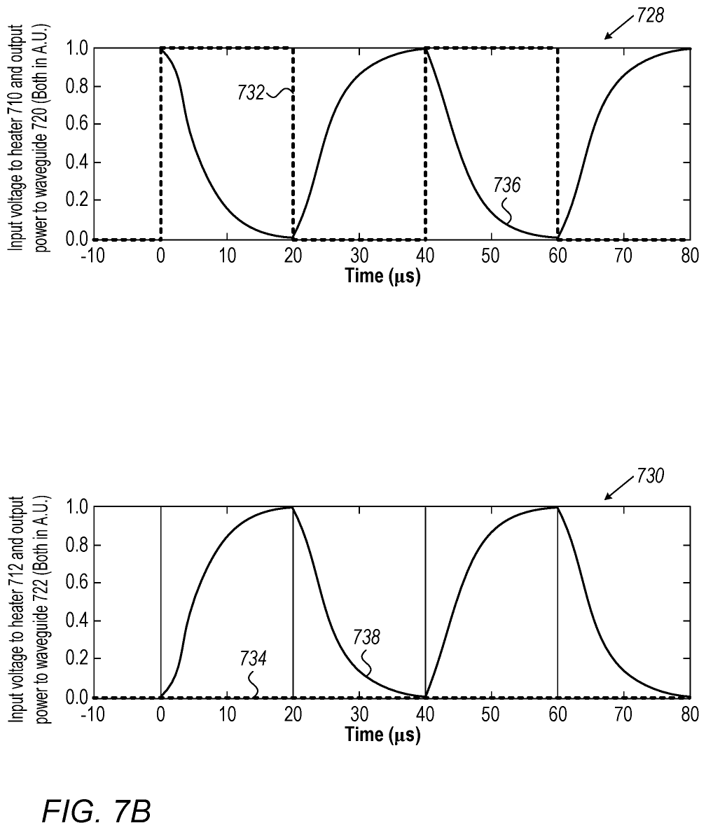

FIG. 7A is a block diagram that schematically illustrates an optical switching tree on a PIC 700, in accordance with an embodiment of the invention. PIC 700 uses thermo-optic switches 702 (labeled TO SW). A fast variant of switches 702, switch 703, is described hereinbelow in detail. Switch 703 comprises a Mach-Zehnder interferometer 704 comprising two branches 706 and 708, with resistive heaters 710 and 712 on respective branches. A mufti-mode interference (MMI) cell 714 serves as a splitter, to split a coherent optical signal from an incoming waveguide 718 between the input ends of the two branches 706 and 708. Another MMI cell 716 serves as a mixer, to mix the optical signals from the output ends of branches 706 and 708 into one of two outgoing waveguides 720 or 722, depending on the optical phase difference between the branches. Digital controllers 724 and 726 set the voltage applied to the respective resistive heaters 710 and 712 and thus toggle the setting of the switch between the two outgoing waveguides 720 and 722. Controller 726 is shown in a dashed-line frame to signify that in some embodiments, a single controller with a switched output can be used to drive both heaters 710 and 712. Controllers 724 and 726 may be advantageously implemented using digital/analog converters to generate the waveforms for driving heaters 710 and 712, and are thus labeled I-DAC 1 and I-DAC 2, respectively.

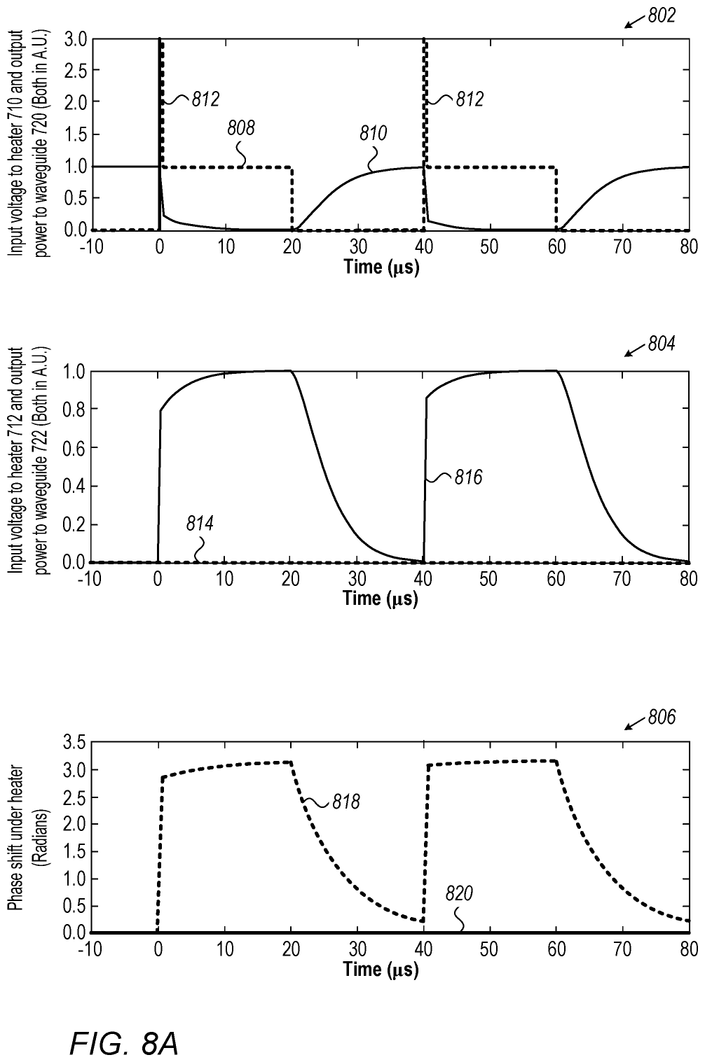

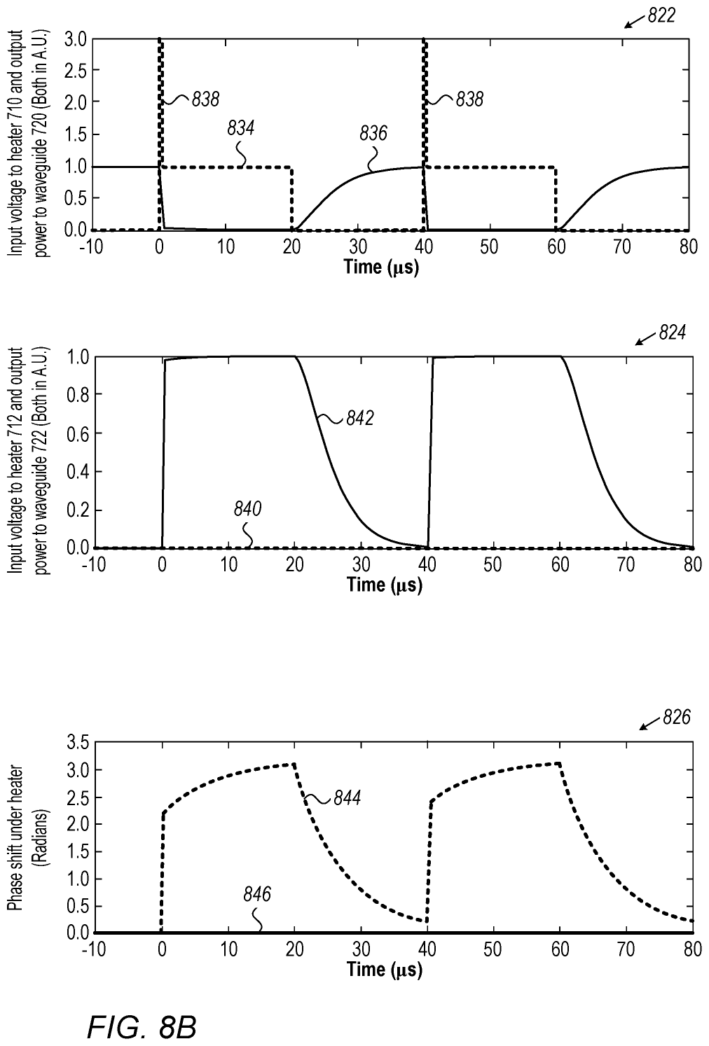

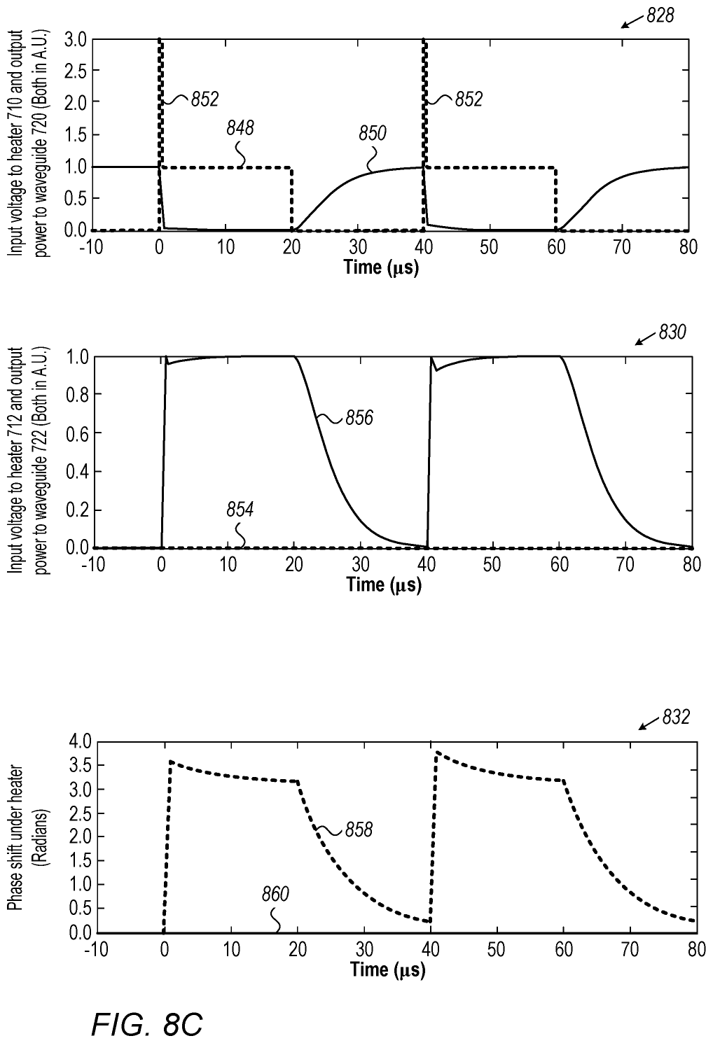

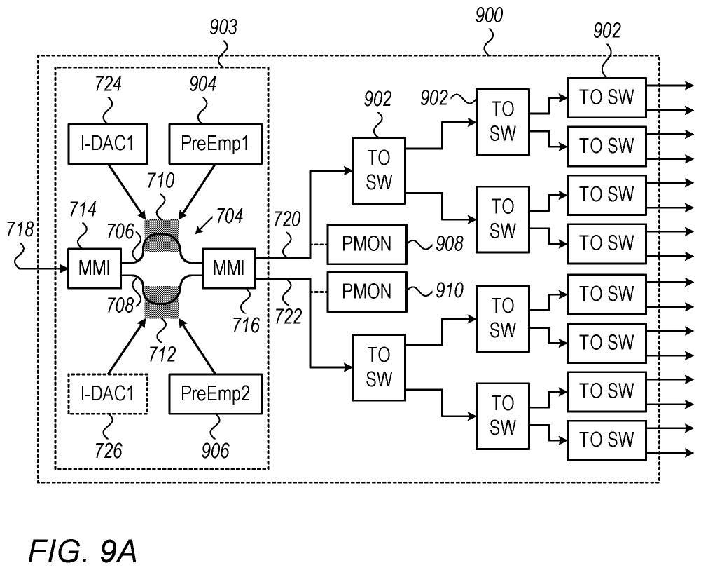

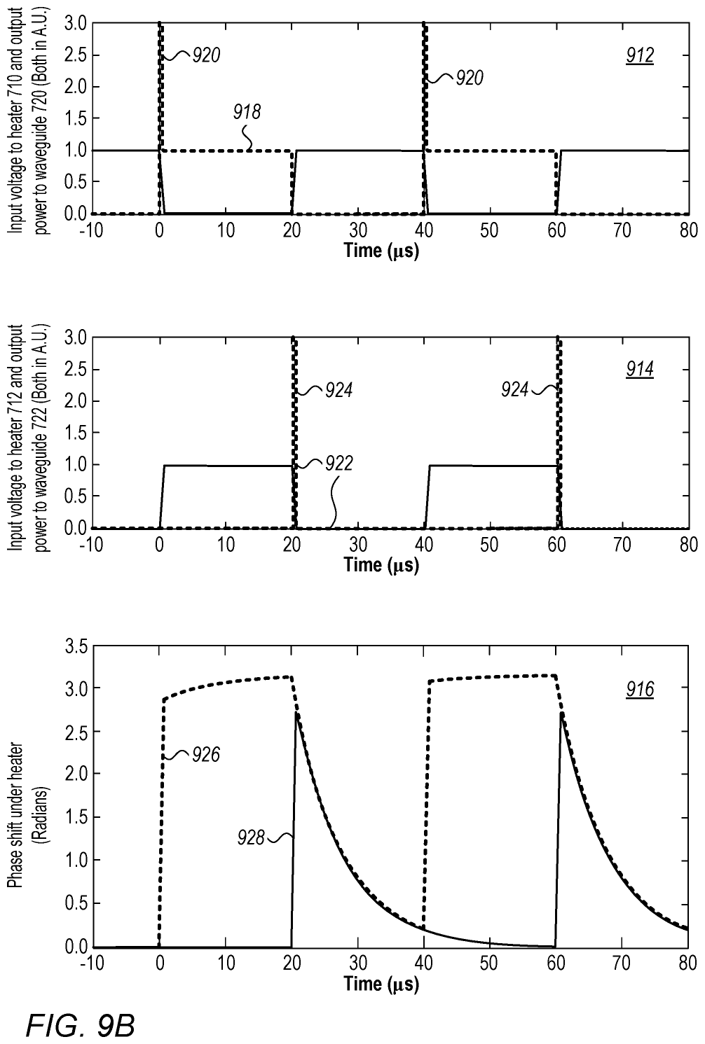

Switches 702 are similar to switch 703, but may use a simpler drive scheme in order to reduce the size and complexity of the circuits on PIC 700. Switch 703 implements a push-pull scheme, in which heaters 710 and 712 are driven in alternation, to provide faster switching than switch 702 and toggle the mixed optical signal between the outputs of switch 703. As will be detailed in FIGS. 8A-8C and 9A-9C, switch 703 may be sped up even more by using a pre-emphasis voltage pulse as part of the push-pull scheme each time the outputs are toggled.

As is shown in FIG. 7A, switch 703 is used only in the first tier of switches in PIC 700. Thus, the fast switch 703 is used judiciously only where it is needed, while switches 702 are used elsewhere in the switching tree of PIC 700. Although the pictured examples in FIG. 7A and in the figures hereinbelow show the enhanced switch 703 in only a single location in the first tier, in other embodiments similar fast thermo-optical switches may be deployed in other tiers, in addition to or instead of the first tier.

FIG. 7B shows plots 728 and 730, schematically illustrating the response of switch 703 to voltages applied to resistive heaters 710 and 712 in a basic implementation, in accordance with an embodiment of the invention. Plots 728 and 730 show curves of respective voltages 732 and 734 applied over time to respective resistive heaters 710 and 712 in switch 703 of FIG. 7A, as well as the output optical powers 736 and 738 in waveguides 720 and 722. (In the present embodiment voltage 734 is zero.) Application of a voltage to one of the two heaters (to heater 710 in FIG. 7B) enables fast turn-on initially, but thereafter the switching speed is controlled by the rate of cooling of the branches of the waveguide, which is inherently slow. The speed of switching of optical power between the two outgoing waveguides 720 and 722 is limited by the same token. In this example, the switching time is about 10 μs.

FIGS. 8A, 8B, and 8C show plots schematically illustrating the response of switch 703 (FIG. 7A) to voltages applied over time to resistive heaters 710 and 712 in an implementation using a pre-emphasis voltage, in accordance with embodiments of the invention.

In these embodiments, a pre-emphasis voltage is applied for a short period of time when switch 703 is turned on. The addition of a pre-emphasis voltage to one of the resistive heaters 710 or 712 for a short period reduces the turn-on time of switch 703 to about 1 us in the present embodiment. For the sake of comparison, three different durations of the pre-emphasis voltage pulses are shown in FIGS. 8A-8C hereinbelow. The turn-off time, however, is still limited by the rate of cooling. In the present embodiment the pre-emphasis voltage is applied by I-DAC 1. Alternatively, a pre-emphasis voltage may be applied to either of heaters 710 or 712 by a controller parallel to I-DAC 1 or I-DAC 2, as will be shown in FIG. 9A hereinbelow.

FIG. 8A shows plots 802, 804, and 806. In plot 802, a curve 808 shows the input voltage to heater 710 and a curve 810 shows the power in waveguide 720, both in arbitrary units (A.U.). The pre-emphasis voltage comprises a sharp peak 812 at each rising edge of curve 808, with a peak amplitude of 3 A.U. and a width of 0.6 μs. In plot 804, a curve 814 shows the input voltage to heater 712 (zero in the present embodiment) and a curve 816 shows the power in waveguide 722. A comparison of curve 816 to curve 738 in FIG. 7B shows that the turn-on time demonstrated in curve 816 is faster than that in curve 738. In plot 806, curves 818 and 820 show the optical phase shifts under respective resistive heaters 710 and 712.

FIG. 8B shows plots 822, 824, and 826, and FIG. 8C shows plots 828, 830, and 832, similar to plots 802, 804, and 806 of FIG. 8A.

In plot 822 of FIG. 8B, a curve 834 shows the input voltage to heater 710 and a curve 836 shows the power in waveguide 720. The pre-emphasis voltage comprises sharp peaks 838 with widths of 0.8 μs. In plot 824, a curve 840 shows a zero input voltage to heater 712, and a curve 842 shows the power in waveguide 722. The turn-on time of curve 842 is even faster than that of curve 816. In plot 826, curves 844 and 846 show the optical phase shifts under respective resistive heaters 710 and 712.

In plot 828 of FIG. 8C, a curve 848 shows the input voltage to heater 710 and a curve 850 shows the power in waveguide 720. The pre-emphasis voltage comprises sharp peaks 852 with widths of 1.0 μs. In plot 830, a curve 854 shows a zero input voltage to heater 712 and a curve 856 shows the power in waveguide 722. The turn-on time of curve 856 is similar to that of curve 842, but shows some distortion immediately after the power reaches its maximum. In plot 832, curves 858 and 860 show the phase shifts under respective resistive heaters 710 and 712.

FIG. 9A is a block diagram that schematically illustrates a thermo-optic switching tree on a PIC 900, in accordance with an embodiment of the invention. In this embodiment, pre-emphasis voltages are applied to both resistive heaters 710 and 712, on both branches 706 and 708 of Mach-Zehnder interferometer 704. In the pictured example, this sort of push-pull pre-emphasis scheme is applied only to the first tier of the switching tree, to enable fast switching between the upper and lower sub-trees in the network. Alternatively or additionally, switches in other tiers may be driven in this manner for fast switching.

PIC 900 comprises thermo-optic switches 902 similar to switches 702 in PIC 700 (FIG. 7A), with the addition of separate pre-emphasis voltage controllers 904 and 906 to a first-tier switch 903, as will be detailed hereinbelow. Switch 903 is similar to switch 703 (FIG. 7A). Items in switch 903 that are similar or identical to those in switch 703 are indicated by the same labels. Pre-emphasis voltage controllers 904 and 906, labeled PreEmp 1 and PreEmp 2, are shown as separate functional blocks for the sake of conceptual clarity. In practice, however, the pre-emphasis function may be integrated into digital controllers 724 and 726, representing a part of the voltage waveforms that are applied to resistive heaters 710 and 712. Monitoring photodiodes 908 and 910, labelled PMON can be used, to verify the current state of switch 903 and adjust the voltages if necessary for more precise switching.

FIG. 9B shows three plots 912, 914, and 916 illustrating schematically the response of switch 903 to the voltages applied by digital controllers 724 and 726, in accordance with an embodiment of the invention.

In plot 912, a curve 918 shows the input voltage to heater 710, wherein the input voltage is a sum of the basic switching voltage and the pre-emphasis voltage. The pre-emphasis voltage comprises peaks 920 located at the rising edges of the input voltage waveform. In this example, the width of each peak 920 is 0.8 μs. A curve 920 shows the output power from switch 903 into waveguide 720.

In plot 914, a curve 922 shows that only pre-emphasis voltage peaks 924 are applied to heater 712. Peaks 924 are located at the falling edges of the input voltage waveform to heater 710 (curve 918). The width of each peak 924 is 0.75 μs.

In plot 916, curves 926 and 928 show respective optical phase shifts applied to branches 706 and 708 by heaters 710 and 712.

While driving heaters 710 and 712 with the respective voltages shown in plots 912 and 914, the temperatures of the two branches of the switch increase continually in multiple cycles of alternating steps. Thus, the optical output of the switch toggles rapidly between outgoing waveguides 720 and 722 at each step. In other words, in the first step, the upper branch 706 (for example) is rapidly heated, with pre-emphasis voltage, by an increment ΔT, followed in the next step by rapid heating of the lower branch 708 by ΔT, followed by rapid heating of the upper branch 706 to 2ΔT, and so forth. The speed of switching is thus controlled by the fast heating time and is not limited by the slower cooling times of the heaters.

After a certain number of rapid switching cycles, the switch is allowed to cool off, after which the rapid switching operation can resume. Monitoring photodiodes (PMON) can be used, as shown in FIG. 9A, to verify the current state of the switch.

### Beam Displacers and Circulators

Transceiver cell 400 that is shown in FIG. 4 is a monostatic cell, in the sense that the transmit and receive axes are collinear at the edge of the cell. (PBSR 404 within cell 400 separates the received beam from the transmitted beam.)

In bistatic cells, on the other hand, the receive axis is displaced transversely relative to the transmit axis at the edge of the cell. The reflection of a given transmitted beam from the target scene, however, is collinear with the transmitted beam (assuming the speed of the scanning mirror is slow enough so that scan walk-off is insignificant). There is therefore a need to displace the axis of the received beam relative to that of the transmitted beam so as to match the displacement between the transmit and receive axes of the transceiver cell. The embodiments that are shown in the figures that follow and are described hereinbelow provide optical components that can be used for this purpose.

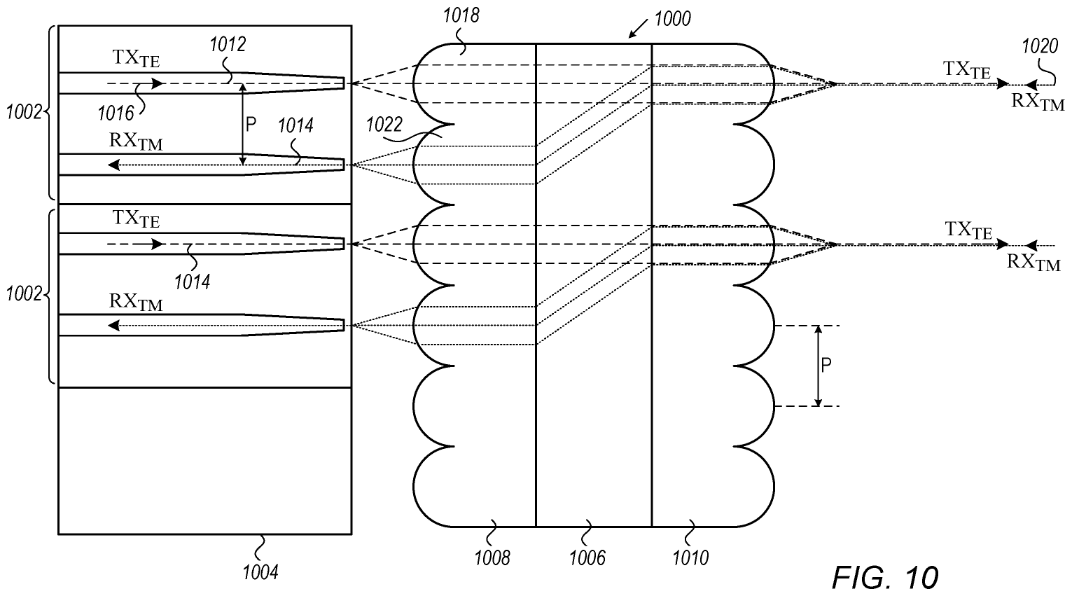

FIG. 10 is a schematic top view of a micro-optic beam displacer 1000, which is used for this purpose together with an array of transceiver cells 1002 in a PIC 1004, in accordance with an embodiment of the invention. Beam displacer 1000 comprises a layer of a birefringent material, such as a birefringent crystal 1006, sandwiched between a pair of microlens arrays 1008 and 1010. The microlens arrays have a pitch P equal to the separation between adjacent transmit and receive axes 1012 and 1014 of each transceiver cell 1002. This pitch P is half the pitch (2P) of the transceiver cells themselves. Alternatively, microlens array 1010 may have a pitch of 2P. matching the pitch of the combined transmit and receive axes at the outer side of beam displacer 1000.

In this embodiment, axes 1012 and 1014 are defined by the locations of corresponding waveguides and edge couplers at the edge of PIC 1004 that is adjacent to beam displacer 1000. and microlens array 1008 is aligned with these axes. The thickness and birefringence of crystal 1006 are selected such that light of one polarization entering the crystal through one of the microlenses in array 1008 or 1010 is deflected and thus displaced laterally by a distance equal to the pitch of the microlens arrays, while light of the orthogonal polarization, passes through the layer without being deflected.

Thus in the present example, each transceiver cell 1002 emits a TE-polarized transmitted beam 1016, denoted by TX_{TE}, which is collimated by a corresponding microlens 1018 and passes through birefringent crystal 1006 toward the target. The TM component of a reflected beam 1020, denoted by RX_{TM}, is displaced laterally by birefringent crystal 1006 by an amount equal to the pitch P of microlens array 1008 and is thus focused by a next microlens 1022 in array 1008 along an appropriate receive axis 1014. The axes of the TX and RX beams are combined at microlens array 1010. The TE component of reflected beam 1020 is disregarded in this embodiment.

The notation of TX for a transmitted beam and RX for a reflected beam, with subscripts of TE and TM for the respective polarization components of the electrical field, is followed also in the description hereinbelow.

Although FIG. 10 and the figures that follow show one-dimensional (linear) arrays of transceiver cells and microlenses, the principles of these embodiments may similarly be implemented in two-dimensional arrays.

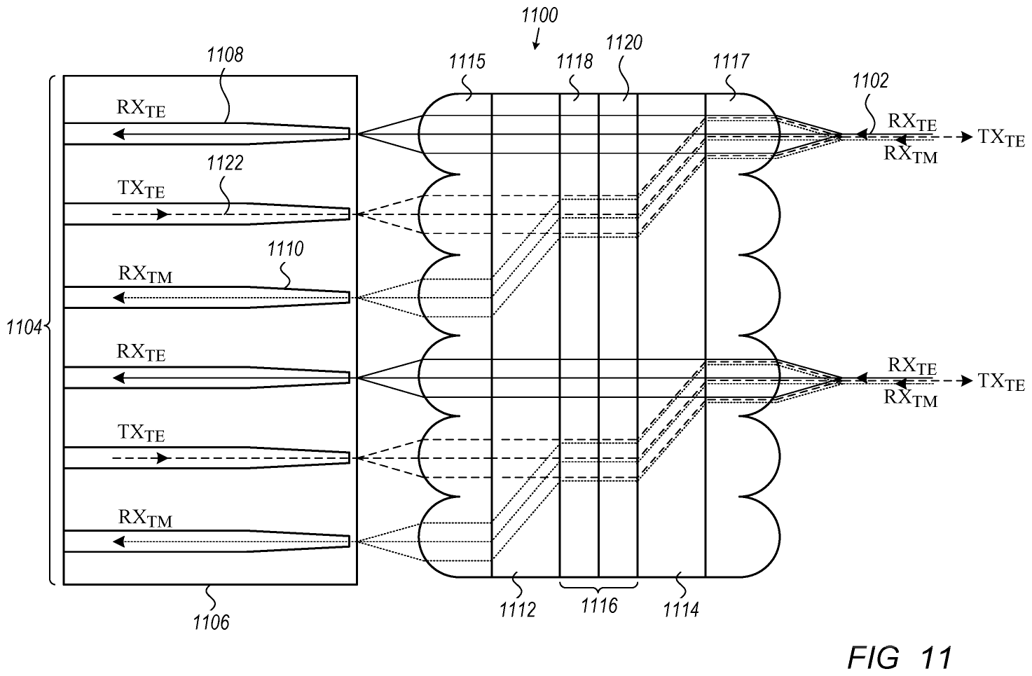

FIG. 11 is a schematic top view of a micro-optic beam displacer 1100 in which both the TM and TE components of a reflected beam 1102 are coupled into a transceiver cell array 1104, in accordance with another embodiment of the invention. In this embodiment, a PIC 1106 comprises separate input waveguides, 1108 and 1110 for respective TE and TM components of each reflected beam 1102. The pitch of the transceiver cells in this case is three times the pitch of the waveguides in PIC 1106.

Beam displacer 1100 comprises two birefringent layers, for example birefringent crystals 1112 and 1114, on opposing sides of a directional polarization rotator 1116, which rotates by 90° the polarization of the light passing therethrough in one direction without rotating the polarization of the light passing therethrough in the opposite direction. In the present embodiment, polarization rotator 1116 comprises a Faraday rotator 1118 (for example, a latchable garnet rotator) and a half-wave plate 1120. The assembly of birefringent crystals 1112 and 1114 and directional polarization rotator 1116 is, similarly to beam displacer 1000 (FIG. 10), sandwiched between a pair of microlens arrays 1115 and 1117. (Although both microlens arrays 1115 and 1117 are shown in FIG. 11 as having the same pitch as the waveguides in PIC 1106, the pitch of microlens array 1117 may alternatively be three times the pitch of the waveguides.) Directional polarization rotator 1116 converts TE-polarized transmitted beam 1122 to TM, so that it is displaced onto the axis of the TE-polarized component of reflected beam 1102. The TM-polarized component of reflected beam 1102 remains TM-polarized through directional polarization rotator 1116 and is thus displaced by both birefringent crystals 1114 and 1116 into waveguide 1110.

FIG. 12 is a schematic top view of a micro-optic beam displacer 1200 in which both the TM and TE components of a reflected beam 1202 are coupled into a transceiver cell 1204, in accordance with an alternative embodiment of the invention. In this embodiment, the same input waveguide 1206 receives both the TE and TM components of each reflected beam 1202. Similarly to displacer 1100 (FIG. 11), beam displacer 1200 here, too, includes two birefringent crystals 1208 and 1210 on opposing sides of a directional polarization rotator 1212, comprising a Faraday rotator 1214 and a half-wave plate 1216, all sandwiched between a pair of microlens arrays 1218 and 1220. However, in this case the axis of second crystal 1210 is flipped by 180° relative to first crystal 1208, so that the two crystals deflect the TM component in opposite directions. Consequently, the TE and TM components are output from beam displacer 1200 along the same axis 1222.

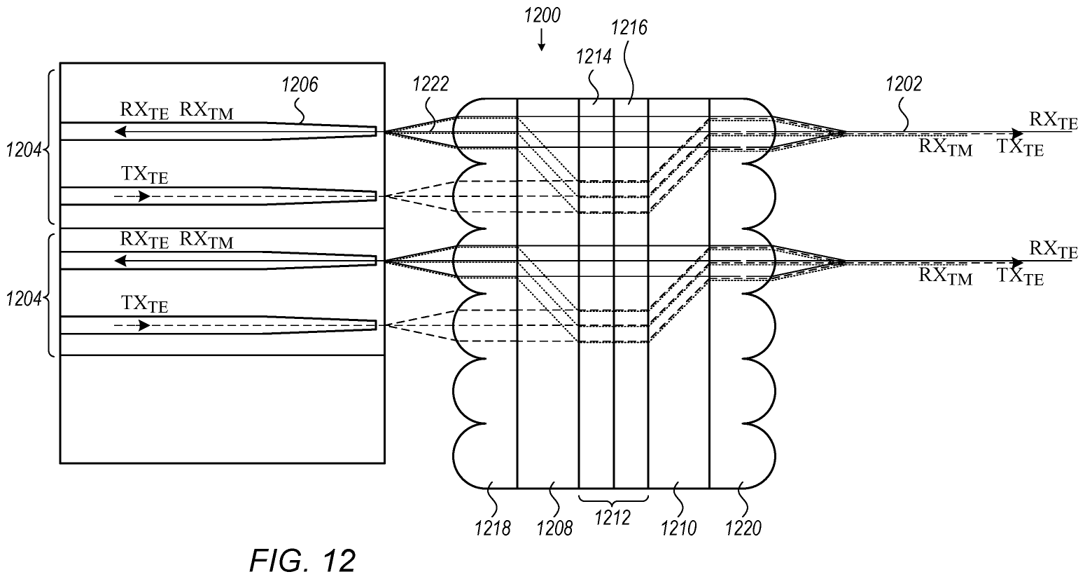

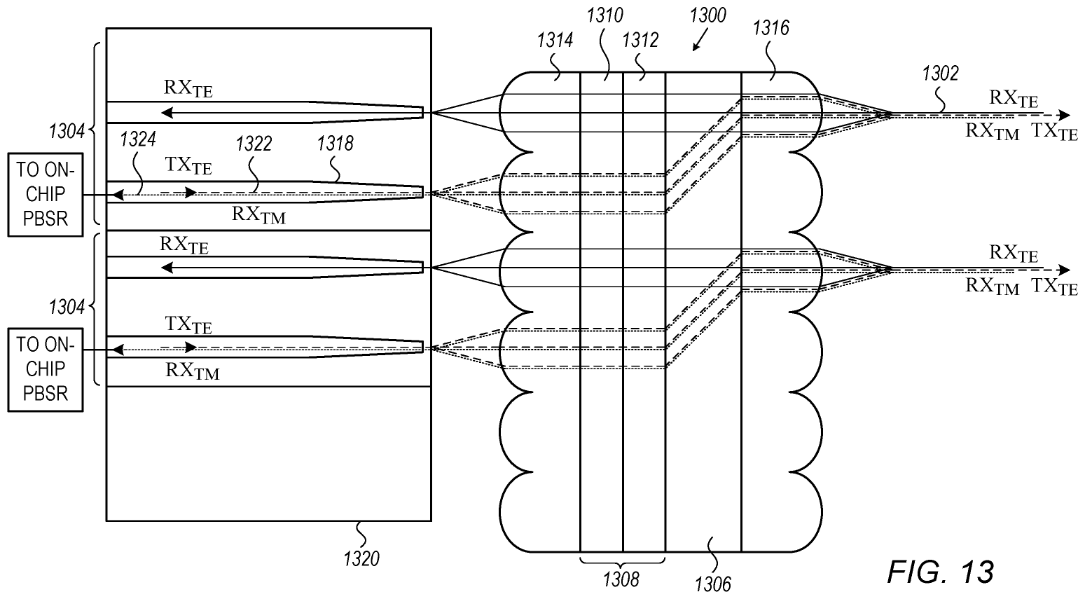

FIG. 13 is a schematic top view of a micro-optic beam displacer 1300 in which both the TM and TE components of a reflected beam 1302 are coupled into a transceiver cell 1304, in accordance with another embodiment of the invention. In this embodiment, beam displacer 1300 comprises a single birefringent crystal 1306 with a directional polarization rotator 1308, which comprises, similarly to polarization rotator 1212 (FIG. 12), a Faraday rotator 1310 and a half-wave plate 1312. Birefringent crystal 1306 and directional polarization rotator 1308 are sandwiched between a pair of microlens arrays 1314 and 1316. Beam displacer 1300 thus directs the TM-component of reflected beam 1302 into a transmit waveguide 1318. A polarization beamsplitter rotator (PBSR, not shown in the figure) on PIC 1320 separates a TM-component 1322 of reflected beam 1302 from a TE-polarized transmitted beam 1324.

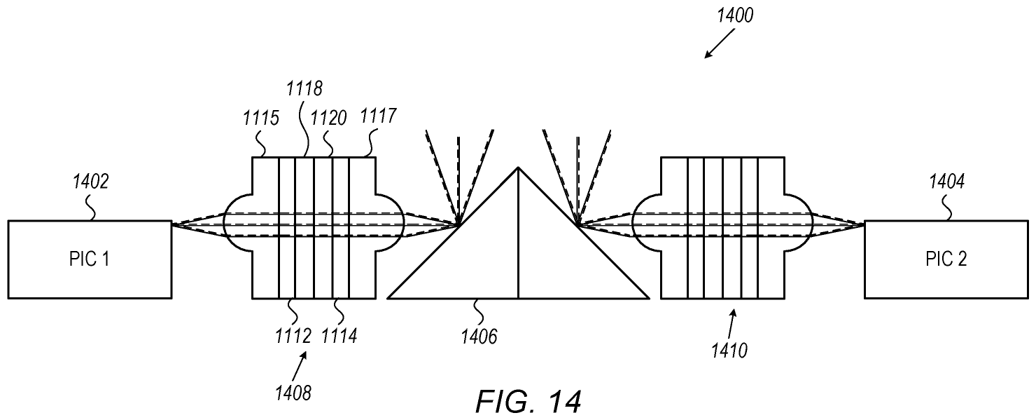

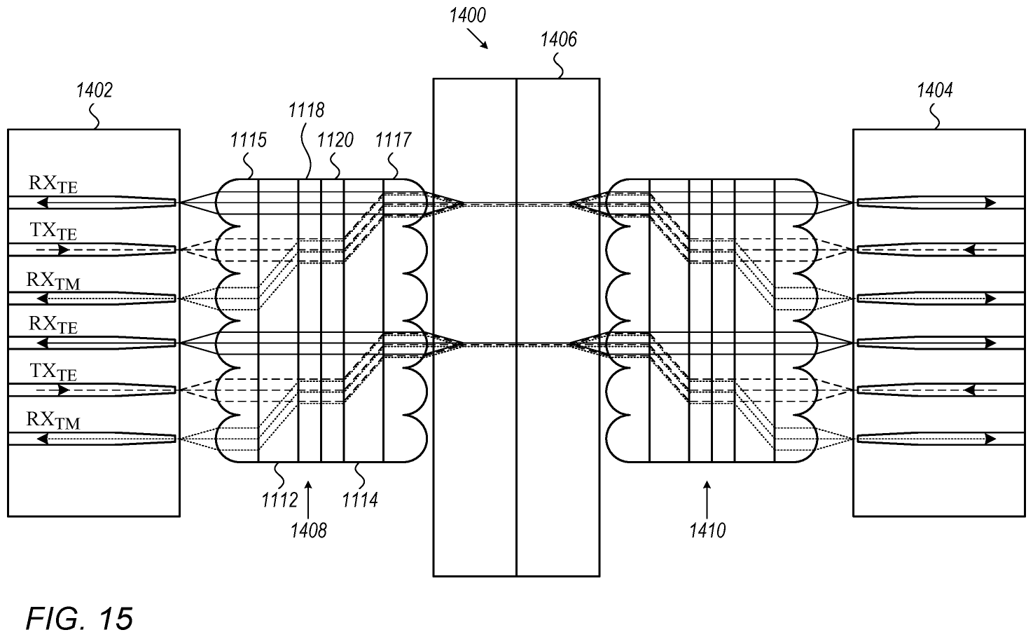

FIGS. 14 and 15 are schematic side and top views, respectively, of a transceiver array device 1400 with micro-optic beam displacers 1408 and 1410, in accordance with an embodiment of the invention. The pictured device comprises a pair of PICs 1402 and 1404 with a central turning mirror 1406, as in the embodiment of FIG. 2. Each PIC 1402, 1404 has a respective micro-optic beam displacer 1408, 1410 of the type that was described above with reference to FIG. 11. Alternatively, a micro-optic beam displacer of the type shown in FIG. 12, as well as other types of beam displacers in accordance with the principles described herein, may be used in this embodiment. The beam displacers shown in the figures that follow may similarly be replaced by these sorts of variants.

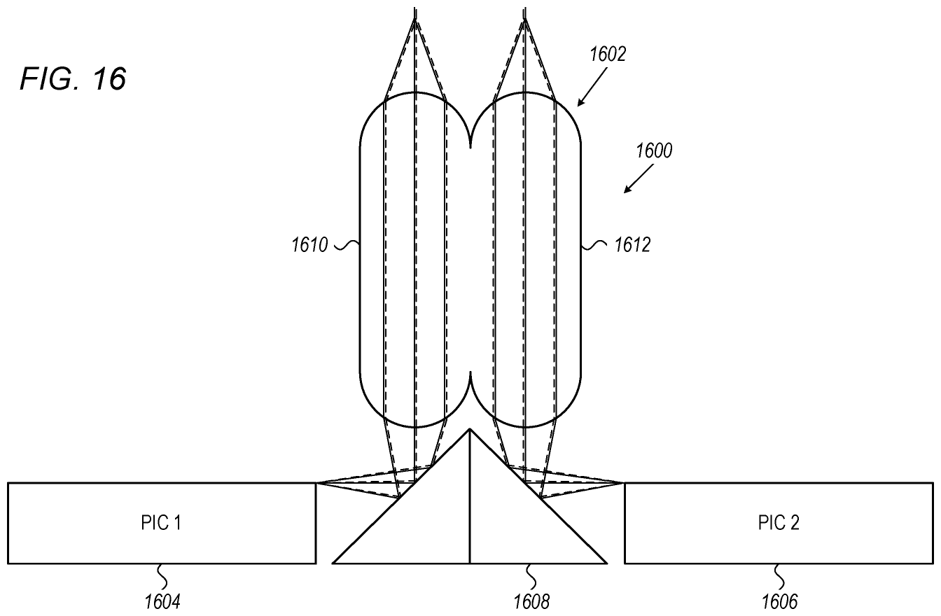

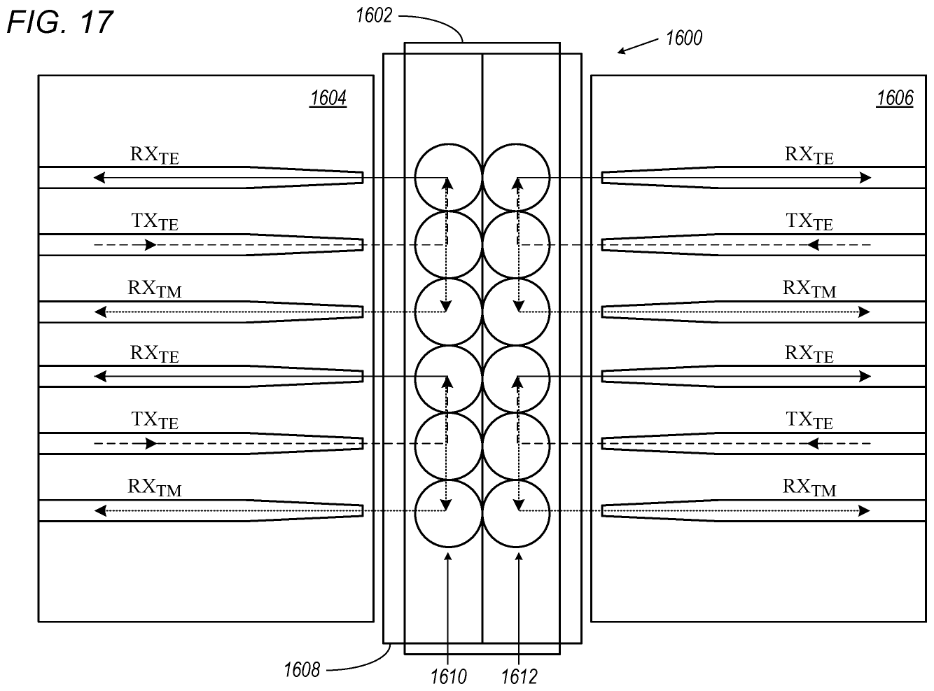

FIGS. 16 and 17 are schematic side and top views, respectively, of a transceiver array device 1600 with a micro-optic beam displacer unit 1602, in accordance with another embodiment of the invention. Device 1600, too, comprises a pair of PICs 1604 and 1606 with a central turning mirror 1608, as in the embodiment of FIGS. 14 and 15; and each PIC 1604, 1606 has an adjacent micro-optic beam displacer 1610 and 1612, respectively, of the type that was described above with reference to FIG. 11. In the present embodiment, however, micro-optic beam displacers 1610 and 1612 are mounted above turning mirror 1608, rather than between PICs 1604 and 1606 and the turning mirror as in the preceding embodiment. In other words, turning mirror 1608 is disposed between PICs 1604, 1606 and beam displacers 1610 and 1612.

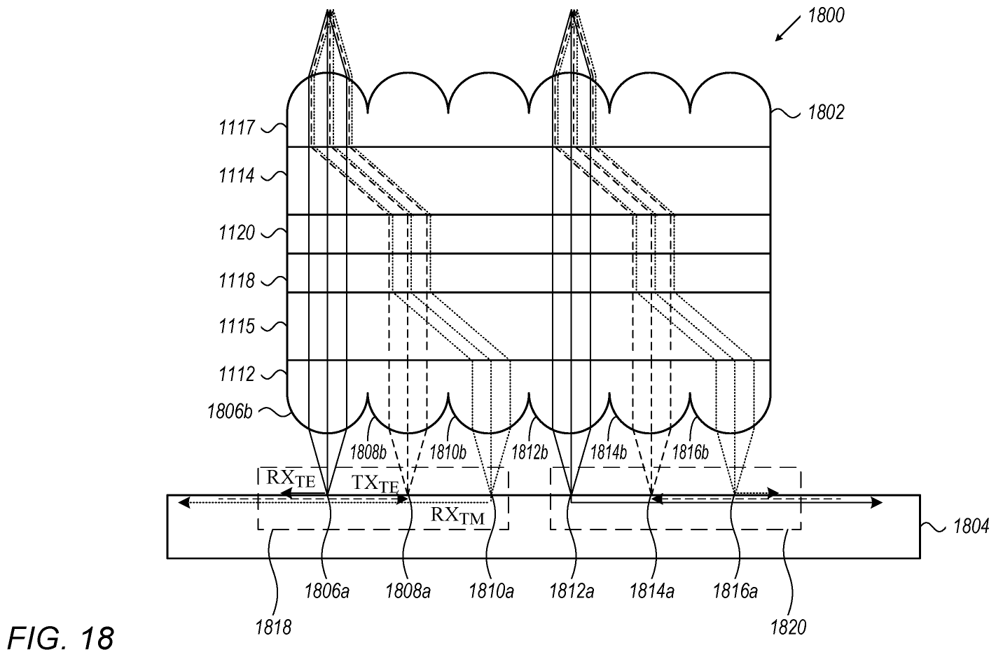

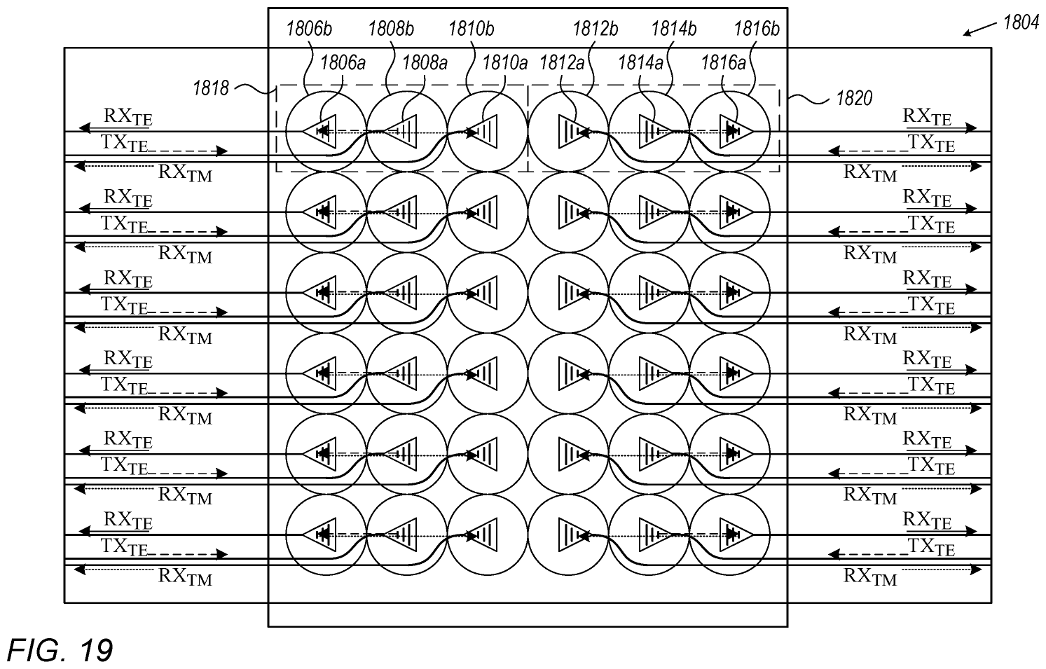

FIG. 18 is a schematic side view of a transceiver array device 1800 with a micro-optic beam displacer 1802, in accordance with an alternative embodiment of the invention. In this embodiment, a PIC 1804 comprises vertical couplers 1806a, 1808a, 1810a, 1812a, 1814a, and 1816a (as will be further detailed in FIG. 19 hereinbelow), such as gratings or micromirrors, on the surface of the PIC. The vertical couplers deflect the transmitted beams upward, away from the PIC, as well as deflecting the reflected beams back into the waveguides in the plane of the PIC. Vertical couplers 1806a, 1808a, 1810a, 1812a, 1814a, and 1816a are aligned with respective microlenses 1806b, 1808b, 1810b, 1812b, 1814b, and 1816b. Micro-optic beam displacer 1802, which is mounted above PIC 1804, is of the type that was described above with reference to FIG. 11.

Two transceiver cells 1818 and 1820 are shown in the side view of FIG. 18, with further details of the cells shown in FIG. 19 hereinbelow.

FIG. 19 is a schematic top view of PIC 1804 in transceiver array device 1800, in accordance with an embodiment of the invention. For the sake of simplicity, only cells 1818 and 1820 and their components are labeled. Each transceiver cell 1818, 1820, . . . , has three vertical couplers: one for the transmitted beam (for example couplers 1808a and 1814a) and the other two for the TE and TM components, respectively, of the received beam (couplers 1806b and 1810b in cell 1818 and couplers 1812b and 1816b in cell 1820). The vertical couplers are formed at a two-dimensional matrix of locations on the surface of PIC 1804. The microlenses in arrays 1115 and 1117 form two-dimensional arrays, which are aligned with the two-dimensional matrix of vertical couplers.

FIG. 20 is a schematic side view of a transceiver array device 2000 with a micro-optic beam displacer 2002 mounted directly on a PIC 2004, in accordance with still another embodiment of the invention. In this embodiment, micro-optic beam displacer 2002 is of the type shown in FIG. 11, but without the lower microlens array. As in the preceding embodiments, micro-optic beam displacer 2002 comprises upper microlens array 1117, together with one or more layers of a birefringent material (in this case two layers, comprising birefringent crystals 1112 and 1114). Directional polarization rotator 1116, comprising Faraday rotator 1118 and half-wave plate 1120, is contained between the two birefringent layers.

Instead of the lower microlens array, PIC 2004 comprises vertical couplers 2006, 2008, 2010, 2012, 2014, and 2016 with a large mode field diameter (MFD) and small numerical aperture (NA), and with the same pitch as the microlenses in array 1117. Vertical couplers 2006, 2008, 2010, 2012, 2014, and 2016 deflect the transmitted beams into micro-optic beam displacer 2002 and collimate the beams sufficiently to obviate the need for the lower microlenses, as well as focusing and deflecting received beams 2018 into the receive waveguides of PIC 2004.

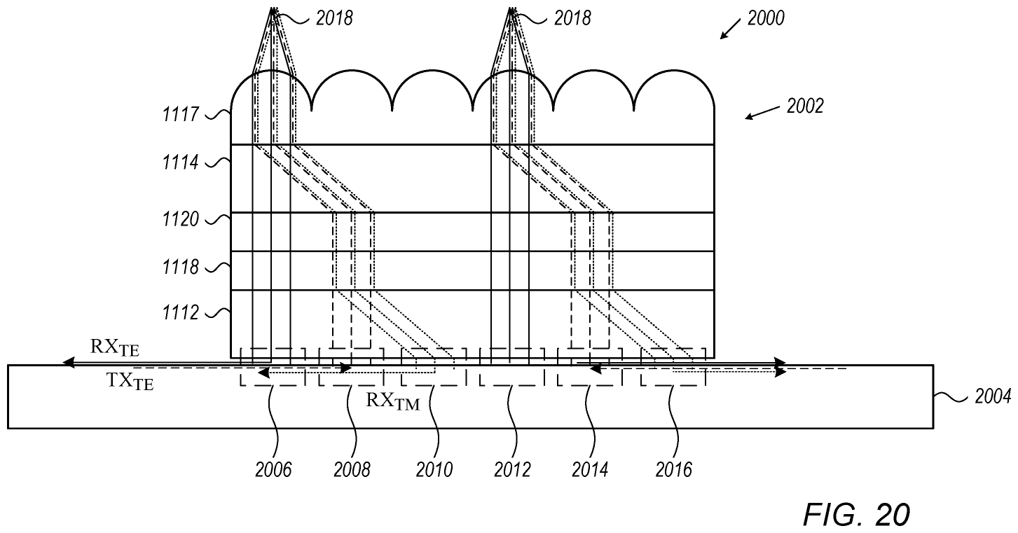

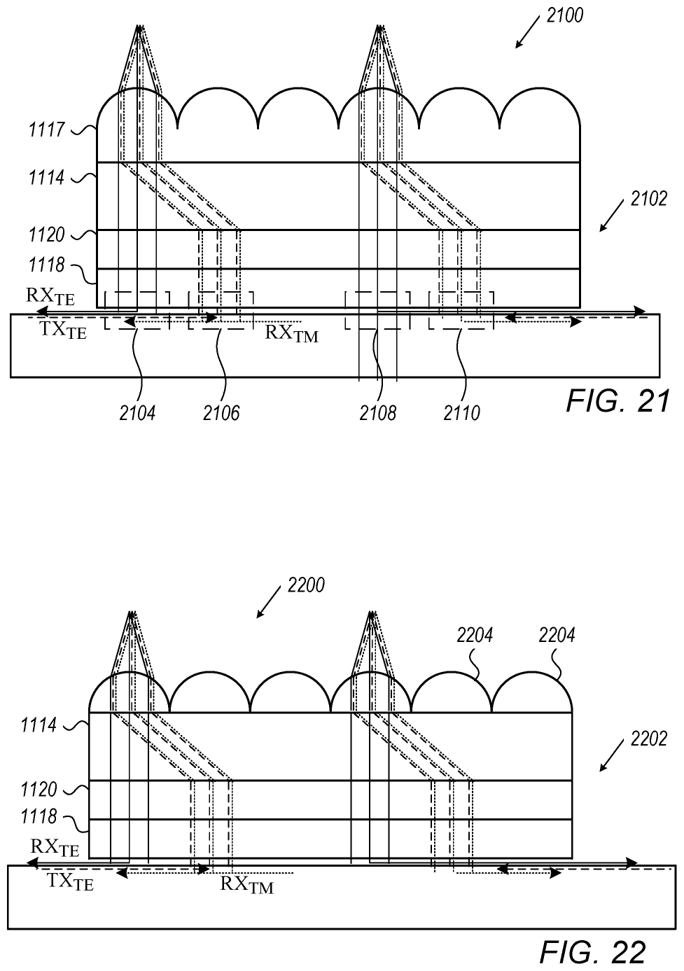

FIG. 21 is a schematic side view of a transceiver array device 2100 with a micro-optic beam displacer 2102, in accordance with another alternative embodiment of the invention. This embodiment is similar to that shown in FIG. 20, except that micro-optic beam displacer 2102 does not include a lower birefringent layer. In this embodiment, too, vertical couplers 2104, 2106, 2108, and 2110 with large MFD, also serve as collimation and collection optics.

FIG. 22 is a schematic side view of a transceiver array device 2200 with a micro-optic beam displacer 2202, in accordance with a further embodiment of the invention. In this embodiment, to reduce the thickness of the optical stack, microlenses 2204 are formed directly on beam displacer 2202, rather than on a separate substrate. In other respects, this embodiment is similar to the embodiment of FIG. 21.

In the embodiments shown in FIGS. 10-22, there may be problems of back-reflections of the transmitted beams from the interfaces between the layers of the beam displacers into the receive waveguides. Such back-reflections can be detrimental to device performance. To reduce the back-reflections, the interfaces may have anti-reflection coatings. Additionally or alternatively, the interfaces may be angled relative to the optical axes of the transmitted and received beams, so that the back-reflections are directed out of the plane of the PIC. A small tilt angle, on the order of one or a few degrees, can be sufficient for this purpose.

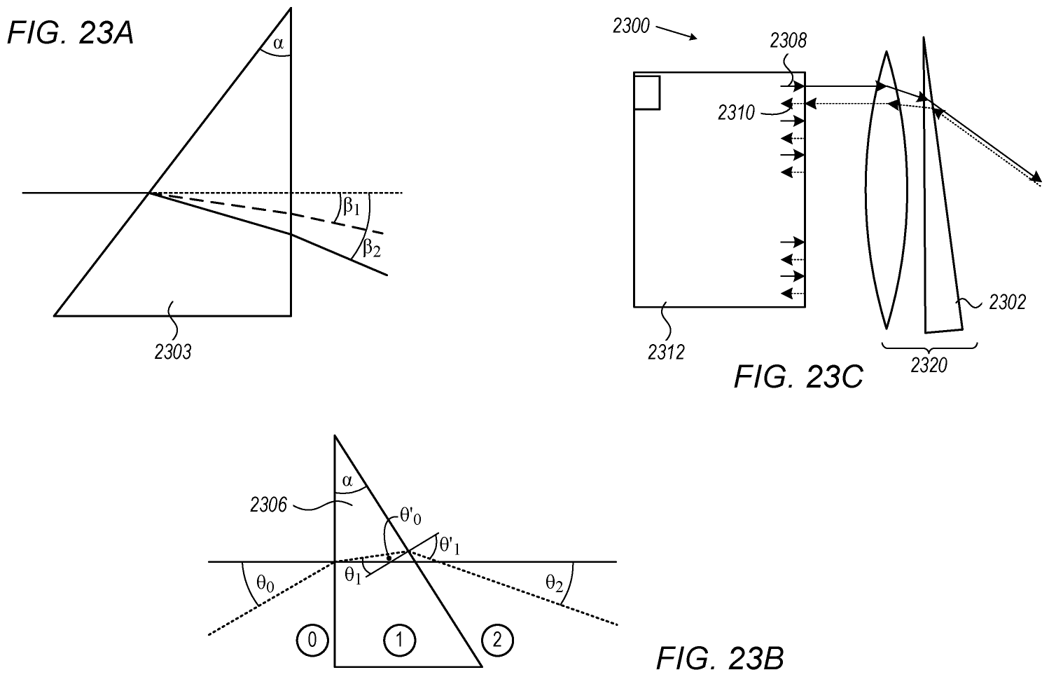

FIGS. 23A, 23B and 23C schematically illustrate a transceiver array device 2300, which includes a beam displacer 2320 based on a birefringent prism 2302, in accordance with an embodiment of the invention. FIGS. 23A and 23B show geometrical and optical features of the prism itself, while FIG. 23C is a side view of device 2300.

As illustrated in FIG. 23A, such a birefringent prism 2303 (similar to prism 2302 but with a larger prism angle α) will deflect both polarization components of an incident ray 2304, but at different deflection angles β₁ and β₂. FIG. 23B shows the total deflection of an incident ray by a prism 2306 of refractive index n, which is determined by the following formula:

$$δ = {θ}_{0} + {θ}_{2} = {θ}_{0} + arcsin ( n sin [ α - arcsin ( \frac{1}{n} sin {θ}_{0} ) ] ) - α .$$

By substituting in the refractive indexes of the birefringent material in prism 2306 for both polarizations (nₒ and nₑ), the difference in the deflection angle δ between the two polarizations can be calculated.

As in the preceding embodiments, PIC 2312 comprises at least one row of optical couplers, which are spaced apart by a predefined pitch and couple respective beams of light into and out of the PIC. FIG. 23C shows how the differential deflection properties of birefringent prism 2302 can be used to align transmit and receive axes 2308 and 2310, respectively, of one of the transceiver cells on PIC 2312. Prism 2302 is aligned in proximity to the row of optical couplers. The birefringence and prism angle are selected such that light of one polarization, for example TE light emitted along transmit axis 2308, passing through the prism from one of the optical couplers, is deflected by a certain angle, while light of the orthogonal polarization, for example TM light returning to receive axis 2310, is deflected by a different angle while passing through the prism. The deflection angles are chosen, using the criteria described above, so that the beams of the TE and TM polarizations that are coupled into and out of adjacent optical couplers in PIC 2312 are combined by prism 2302.

### Pic-Based Polarization Beamsplitter Rotator

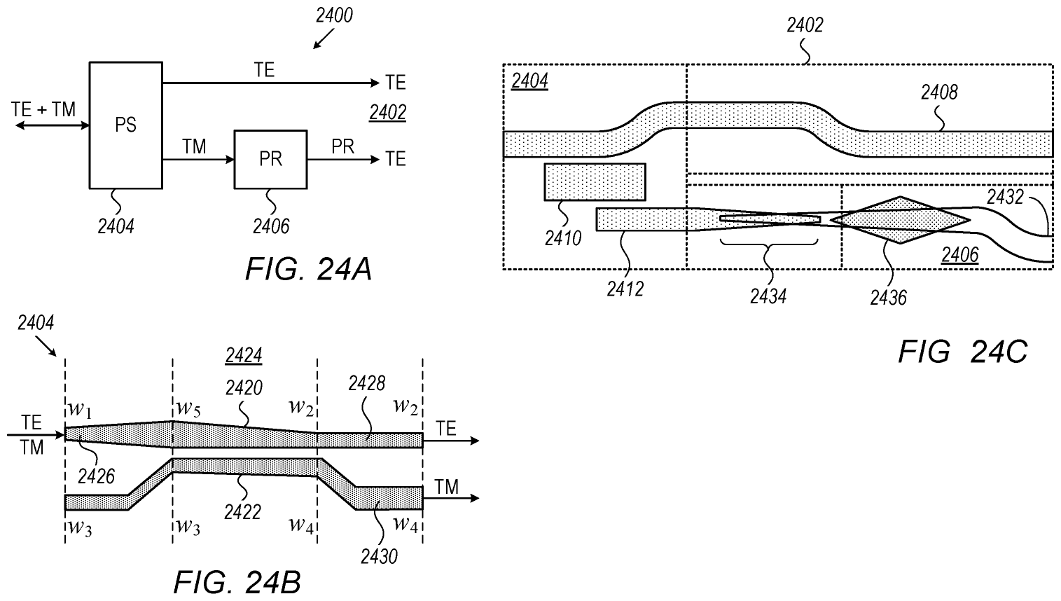

FIG. 24A is a block diagram that schematically illustrates a polarization beamsplitter rotator (PBSR) 2400, which is implemented on a PIC 2402 in accordance with an embodiment of the invention. As in the embodiment shown in FIG. 13 hereinabove, PBSR 2400 transmits a TE beam from PIC 2402 and receives a reflected TM beam from a target and thus separates the incoming received beam from the outgoing transmitted beam to and from each transceiver cell. Alternatively, PBSR 2400 may be configured to transmit a TM beam and receive a reflected TE beam. A polarization splitter (PS) 2404 separates the TE and TM components, and a polarization rotator (PR) 2406 converts the received TM beam to TE or, alternatively, converts the transmitted TE beam to TM. PBSR 2400 can be fabricated efficiently and compactly on a PIC and is thus useful particularly in PIC-based transceiver arrays.

FIG. 24B is a schematic top view of PS 2404, in accordance with an embodiment of the invention. PS 2404 comprises a pair of waveguides 2420 and 2422, which are formed in mutual proximity on a substrate 2424, for example SiN waveguides on a silicon or SiO₂ substrate. A first end 2426 of waveguide 2420 is coupled to receive an input beam or transmit an output beam comprising both TE and TM polarization components. The TE polarization component propagates through waveguide 2420 and is output to or input from a second end 2428. The TM polarization component propagates in waveguide 2422 and is received in or transmitted from an end 2430 alongside end 2428 of waveguide 2420.

Waveguides 2420 and 2422 are tapered to facilitate adiabatic coupling of the TM wave between the waveguides, while the TE wave remains confined within waveguide 2420. For this purpose, waveguide 2420 has a tapered segment whose width decreases in a direction from first end 2426 toward second end 2428 (from width w₅ to width w₂ in FIG. 24B. The width of a corresponding segment in waveguide 2422 increases in the direction from the first end toward the second end, from width w₃ to width w₄. The opposite tapers cause the TM polarization component to be coupled between the tapered segments. For effective coupling, the dimensions are desirably chosen so that w₅>w₄, while w₂ may or may not be equal to w₄. This design is advantageous in supporting broadband coupling and is relatively insensitive to fabrication tolerances.

FIG. 24C is a schematic top view of PBSR 2400, in accordance with a further embodiment of the invention. PBSR 2400 can be fabricated in whole or in part on PIC 2402, including waveguides 2408, 2410, and 2412 in a non-silicon layer, such as SiN, in order to support a high-power transmitted beam.

PS 2404 in this embodiment comprises TE waveguide 2408 and TM waveguide 2412, with an intermediate transition waveguide 2410, which is wider than waveguides 2408 and 2412. The TE component remains well-contained in waveguide 2408. High-order mode coupling through transition waveguide 2410, however, transfers most of the energy in the TM component to waveguide 2412.

PR 2406 is implemented in a silicon layer, below the SiN layer. A dual taper 2434 couples the TM wave between waveguide 2412 in the SiN layer and a waveguide 2432 in the underlying silicon layer. A pair of wings 2434, with thickness less than that of waveguide 2432, facilitates rotation of the polarization of the guided wave between TM and TE.

### Multi-Channel Signal Processing

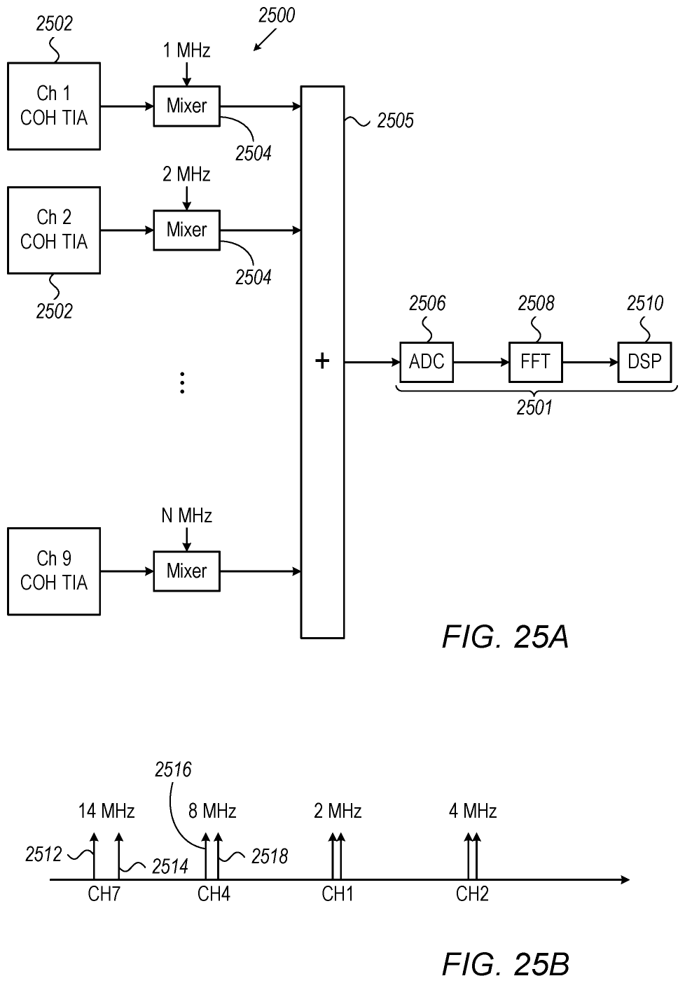

FIG. 25A is a block diagram that schematically illustrates a signal processing scheme for use with a transceiver array 2500, in accordance with an embodiment of the invention. In this embodiment, a single signal processing chain 2501 processes the output signals from multiple transceiver channels simultaneously. This scheme reduces the cost, size, and power consumption of the electronic IC that is used to carry out the processing, although at the possible cost of reduced signal/noise ratio (SNR) and overlap between channels. It can be useful particularly (though not exclusively) in coarse, wide-area scanning to identify regions of interest in a scene. Once a region of interest has been identified, it can be scanned with finer resolution and higher SNR.

In the embodiment of FIG. 25A, N transceiver cells 2502 in array 2500 are assumed to be configured for coherent sensing of reflected light, for example as shown in FIG. 4. A frequency chirp is applied to the transmitted beams, and balanced photodiodes 412 in each cell output a beat signal, which is indicative of the distance and possibly the velocity of the target from which the light is reflected. These signals are amplified by respective transimpedance amplifiers (TIAs). The amplified signals are mixed with carrier waves at different modulation frequencies by respective analog mixers 2504, thus causing cells 2502 to output respective modulated signals at different, respective modulation frequencies. An analog summer 2505 sums the modulated signals (still in the analog domain). In the pictured example, the modulation frequencies are assumed to be integer multiples of 1 MHZ.

The summed analog signal is digitized by an analog-to-digital converter (ADC) 2506, transformed to the frequency domain by a frequency analyzer 2508, for example by a Fast Fourier Transform (FFT), and then processed digitally in a digital signal processor (DSP) 2510 to extract the modulated beat frequencies.

FIG. 25B is a schematic plot of signal outputs from some of the channels of array 2500, in accordance with an embodiment of the invention. Each channel (corresponding to one of transceiver cells 2502) outputs a pair of frequency peaks separated by twice the modulation frequency that was applied to the channel. Thus, in the pictured example, two peaks 2512 and 2514 from channel 7 are separated by 14 MHZ, two peaks 2516 and 2518 from channel 4 are separated by 8 MHZ, and so forth. DSP 2510 is thus able to demultiplex the beat signal frequencies and identify the channels to which they belong based on these peak separations.

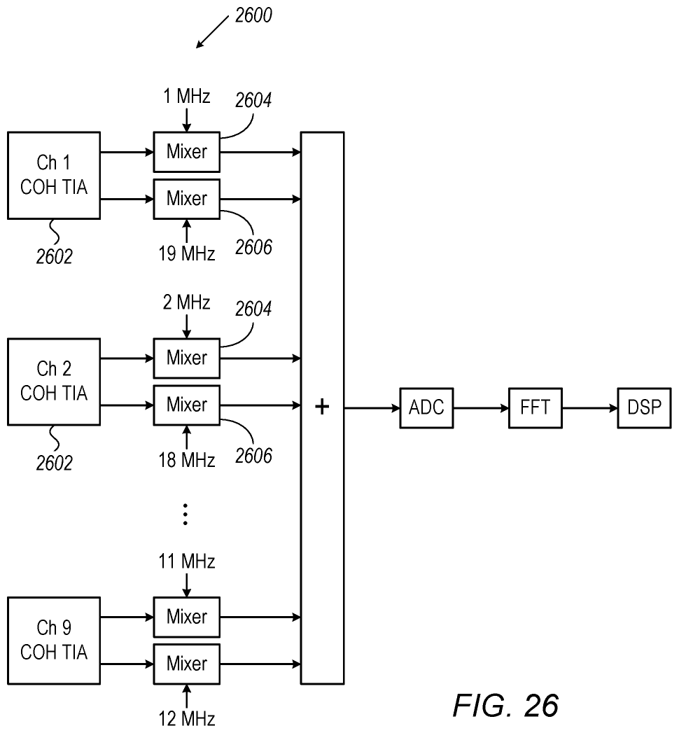

FIG. 26 is a block diagram that schematically illustrates a signal processing scheme for use with a transceiver array 2600, in accordance with an alternative embodiment of the invention. In this case the output from each channel 2602 is mixed with carrier waves in two mixers 2604 and 2606 at two different modulation frequencies, and the modulated signals are all summed together. The summing and processing of the signals is implemented as in the preceding embodiment. The summed signal will contain frequency peaks in pairs, wherein each pair is separated by the difference between the modulation frequencies applied to the corresponding channel.

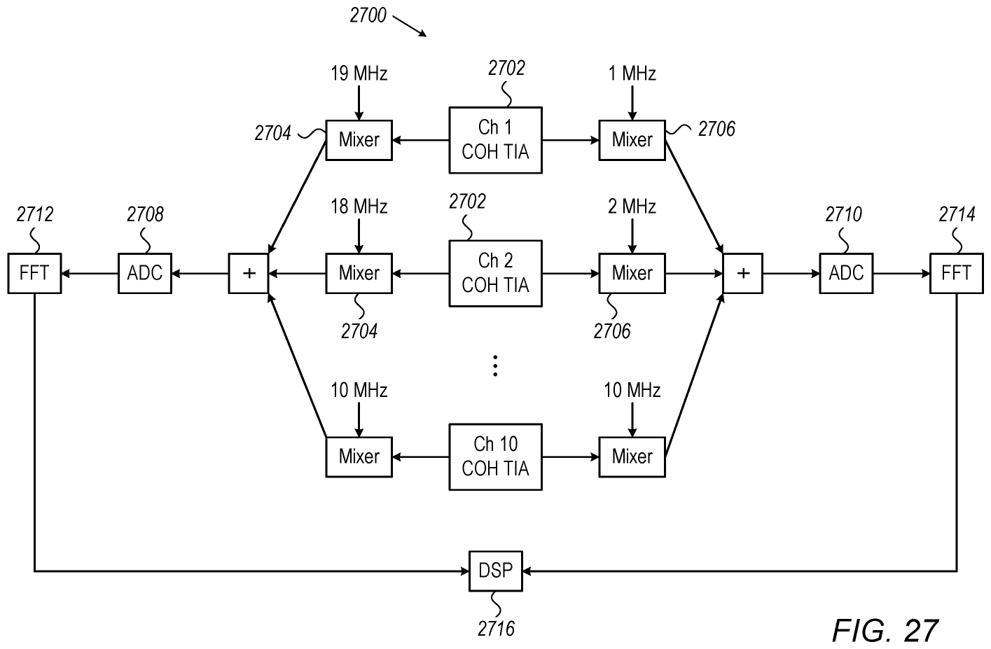

FIG. 27 is a block diagram that schematically illustrates a signal processing scheme for use with a transceiver array 2700, in accordance with yet another embodiment of the invention. In this embodiment, as in the embodiment of FIG. 26, the output from each channel 2702 is mixed with modulation waves in two mixers 2704 and 2706 at two different frequencies. In this case, however, the modulated signals are summed in two separate groups, with signals from mixer 2704 of each channel in one of the groups, and signals from mixer 2706 in the other group. Following digitization by respective ADCs 2708 and 2710 and transformation by frequency analyzers 2712 and 2714 to the frequency domain, a DSP 2716 compares the distribution of peaks in the two groups in order to identify the beat frequency output by each channel.

### Wafer-Level Vertical Coupler

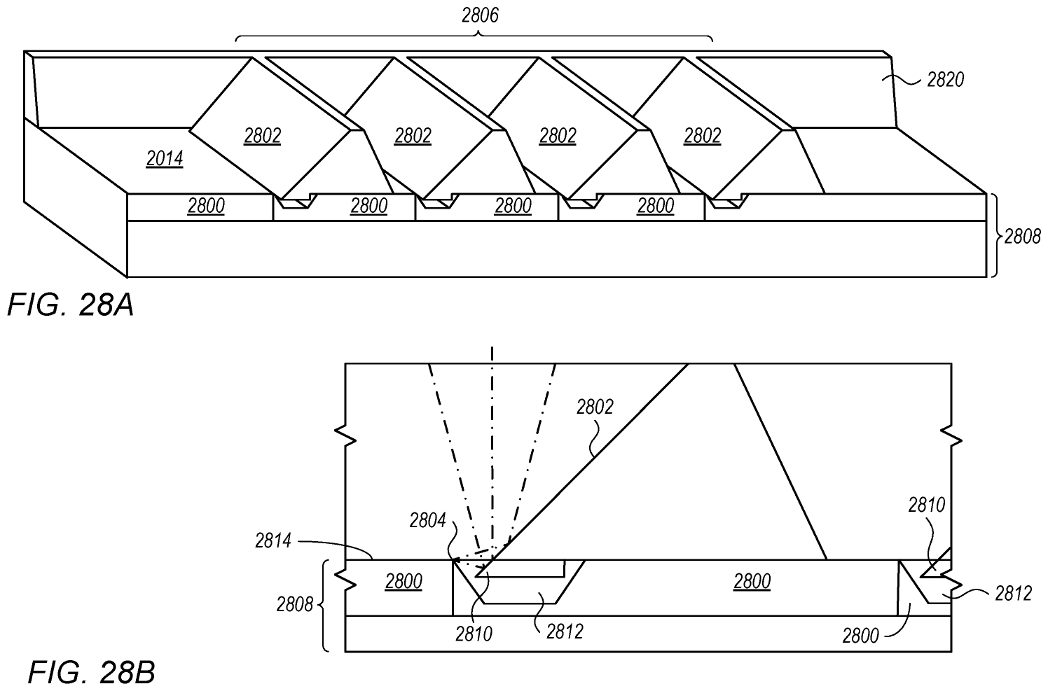

FIGS. 28A and 28B schematically illustrate an array of edge-emitting PICs 2800 with turning mirrors 2802 aligned to couple the beams from each PIC into the vertical direction, in accordance with an embodiment of the invention. FIG. 28A is a pictorial illustration, while FIG. 28B is a sectional detail view. This embodiment addresses the problem of aligning turning mirrors 2802 with edge couplers 2804. In this embodiment, an array of PICs 2800 is formed on a substrate, such as a silicon wafer 2808. Each PIC comprises one or more optical edge couplers 2808 adjacent to the upper surface of the substrate. An array 2806 of turning mirrors 2802 is formed on a mirror substrate, for example another silicon wafer 2820. The mirror substrate is mounted on the upper surface of the PIC substrate such that each turning mirror 2802 in array 2806 is aligned with the optical edge couplers 2804 on a respective PIC 2800. Light is thus coupled into and out of the optical edge couplers via the turning mirrors.

The present embodiment provides a mirror array 2806 that is mounted on top of a finished PIC wafer 2808 and captures the light emitted from one or more edge couplers 2804 in each PIC 2800. Both mirror array 2806 and PICs 2800 are patterned and etched by wafer-scale processing, using semiconductor processing techniques. The mirror array structure includes a “leg” 2810 at the front edge of each mirror 2802, which protrudes into a corresponding cavity 2812 that is etched into an upper surface 2814 of a corresponding PIC 2800, as illustrated in FIG. 28B. Cavity 2812 can be etched using standard PIC processing, such as a wet etch or deep reactive ion etching (DRIE) process. The addition of leg 2810 in cavity 2812 enables mirror 2802 to capture and reflect substantially all the light that is emitted from edge coupler 2804 of PIC 2800 and provides a large collection angle for directing reflected light into the edge of the PIC.

Mirrors 2802 are placed together on PIC wafer 2808 in a simple, accurate alignment step. This approach takes advantage of upper surface 2814 of PIC wafer 2808 as a datum for height. Because both PICs 2800 on wafer 2808 and mirrors 2802 are lithographically defined, the mirrors can be aligned with the PICs with high precision. Mirrors 2802 can be produced from a silicon wafer, for example using a wet etch process on a wafer formed at an offset of 9.7° relative to the <0,0,0>silicon crystal plane. Thus, the etching process will create a reflecting surface inclined at precisely 450 relative to the lower surface of the wafer. (The other crystal plane will be 54.7°+9.7°=64.4°.)

It will be appreciated that the embodiments described above are cited by way of example, and that the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

1-10. (canceled)

11. An optoelectronic device, comprising:
a planar substrate;
an array of optical transceiver cells disposed on the substrate, each transceiver cell comprising an optical transducer configured to couple optical radiation between the transceiver cell and a target external to the substrate;
an optical distribution tree, comprising a hierarchical network of switches interconnected by waveguides disposed on the substrate and coupled to convey coherent radiation from a radiation source to the optical transceiver cells, the hierarchical network comprising at least a first tier of first switches having a first switching time and a second tier of second switches having a second switching time different from the first switching time; and
a controller, which is configured to actuate the switches so as to select different subsets of the optical transceiver cells to receive the coherent radiation from the radiation source at different times.

12. The device according to claim 11, wherein each first switch in the first tier has at least two first outputs coupled respectively to at least two of the second switches in the second tier, while each second switch in the second tier has at least two second outputs coupled to the transceiver cells, and wherein the first switching time is shorter than the second switching time.

13. The device according to claim 12, wherein the optical transceiver cells and the second switches are arranged in first and second groups in different, respective first and second areas of the substrate, and wherein the waveguides interconnect the first and second switches such that one of the first outputs of each first switch is coupled to the first group of the transceiver cells and second switches, while another of the first outputs of each first switch is coupled to the second group of the transceiver cells and second switches.

14. The device according to claim 11, and comprising a scanner, which is configured to scan respective fields of view of the optical transceiver cells across the target, wherein the controller is configured to actuate the switches so as to select different subsets of the optical transceiver cells to convey the coherent radiation toward the target during different sweeps of the scanner across the target.

15. The device according to claim 14, wherein scanning the respective fields of view of the optical transceiver cells across the target defines multiple, respective scan lines across the target, wherein the first switching time is shorter than the second switching time, and wherein the controller is configured to actuate the first switches so as to activate a different group of the scan lines in each sweep across the target.

16. The device according to claim 14, wherein scanning the respective fields of view of the optical transceiver cells across the target defines multiple, respective scan lines across the target, and wherein the controller is configured to actuate the switches so as to activate the scan lines selectively in a region of interest on the target.

17. The device according to claim 11, wherein the controller is configured to process signals output by the transceiver cells to produce a three-dimensional (3D) map of the target.

18. The device according to claim 11, wherein the switches comprise thermo-optic switches.

19. A thermo-optic switch, comprising:
an interferometer comprising first and second waveguides having respective input ends and output ends;
first and second heaters configured to heat the first and second waveguides, respectively;
a splitter coupled to receive a coherent optical signal and to input the optical signal to the input ends both the first and second waveguides;
a mixer coupled to receive and mix the optical signal from the output ends of the first and second waveguides and to direct the mixed optical signal to a first output or a second output of the switch depending on a phase shift between the first and second waveguides; and
a controller, which is coupled to control the first and second heaters so as to switch the mixed optical signal between the first and second outputs.

20. The switch according to claim 19, wherein the controller is configured to drive the first and second heaters in alternation to toggle the mixed optical signal between the first and second outputs.

21. The switch according to claim 20, wherein the controller is configured to drive the first and second heaters with a voltage waveform that includes a pre-emphasis pulse each time the outputs are toggled.

22. The switch according to claim 20, wherein the controller is configured to drive the first and second heaters with respective voltages that cause respective temperatures of the first and second waveguides increase continually over multiple cycles of toggling between the first and second outputs.

23. The switch according to claim 19, wherein the controller comprises first and second digital/analog converters (DACs), which are configured to apply respective voltages to the first and second heaters responsively to respective digital inputs.

24-59. (canceled)

60. A method for producing an optoelectronic device, the method comprising:
forming on a planar substrate an array of optical transceiver cells, each transceiver cell comprising an optical transducer configured to couple optical radiation between the transceiver cell and a target external to the substrate;
coupling an optical distribution tree, comprising a hierarchical network of switches interconnected by waveguides disposed on the substrate, to convey coherent radiation from a radiation source to the optical transceiver cells, the hierarchical network comprising at least a first tier of first switches having a first switching time and a second tier of second switches having a second switching time different from the first switching time; and
coupling a controller to actuate the switches so as to select different subsets of the optical transceiver cells to receive the coherent radiation from the radiation source at different times.

61. The method according to claim 60, wherein each first switch in the first tier has at least two first outputs coupled respectively to at least two of the second switches in the second tier, while each second switch in the second tier has at least two second outputs coupled to the transceiver cells, and wherein the first switching time is shorter than the second switching time.

62. The method according to claim 61, wherein the optical transceiver cells and the second switches are arranged in first and second groups in different, respective first and second areas of the substrate, and wherein coupling the optical distribution tree comprises interconnecting the first and second switches such that one of the first outputs of each first switch is coupled to the first group of the transceiver cells and second switches, while another of the first outputs of each first switch is coupled to the second group of the transceiver cells and second switches.

63. The method according to claim 60, and comprising positioning a scanner to scan respective fields of view of the optical transceiver cells across the target, wherein coupling the controller comprises actuating the switches so as to select different subsets of the optical transceiver cells to convey the coherent radiation toward the target during different sweeps of the scanner across the target.

64. The method according to claim 63, wherein scanning the respective fields of view of the optical transceiver cells across the target defines multiple, respective scan lines across the target, wherein the first switching time is shorter than the second switching time, and wherein actuating the switches comprises actuating the first switches so as to activate a different group of the scan lines in each sweep across the target.

65. The method according to claim 63, wherein scanning the respective fields of view of the optical transceiver cells across the target defines multiple, respective scan the target, and wherein actuating the switches comprises activating the scan lines selectively in a region of interest on the target.

66. The method according to claim 60, and comprising processing signals output by the transceiver cells to produce a three-dimensional (3D) map of the target.

67. The method according to claim 60, wherein the switches comprise thermo-optic switches.

68. A method for switching, comprising:
providing a thermo-optic switch, comprising:
an interferometer comprising first and second waveguides having respective input ends and output ends;
first and second heaters configured to heat the first and second waveguides, respectively;
a splitter coupled to receive a coherent optical signal and to input the optical signal to the input ends both the first and second waveguides; and
a mixer coupled to receive and mix the optical signal from the output ends of the first and second waveguides and to direct the mixed optical signal to a first output or a second output of the switch depending on a phase shift between the first and second waveguides; and
controlling the first and second heaters so as to switch the mixed optical signal between the first and second outputs.

69. The method according to claim 68, wherein controlling the first and second heaters comprises driving the first and second heaters in alternation to toggle the mixed optical signal between the first and second outputs.

70. The method according to claim 69, wherein driving the first and second heaters comprises applying to at least one of the heaters a voltage waveform that includes a pre-emphasis pulse each time the outputs are toggled.

71. The method according to claim 69, wherein driving the first and second heaters comprises applying respective voltages that cause respective temperatures of the first and second waveguides increase continually over multiple cycles of toggling between the first and second outputs.

72. The method according to claim 68, wherein controlling the first and second heaters comprises applying digital inputs to first and second digital/analog converters (DACs), which are configured to apply respective voltages to the first and second heaters responsively to the digital inputs.

73-98. (canceled)
